(19) United States
(12) Patent Application Publication
(10) Pub. No.: US 2024/0326219 A1
(43) Pub. Date: Oct. 3, 2024

(54) ANGLE IMPACT TOOL

(71) Applicant: MAKITA CORPORATION, ANJO-SHI (JP)

(72) Inventors: Kazunori KINOSHITA, Anjo-shi (JP); Takeshi KAMIYA, Anjo-shi (JP)

(21) Appl. No.: 18/613,299

(22) Filed: Mar. 22, 2024

(30) Foreign Application Priority Data
Mar. 30, 2023 (JP) 2023-056404

(51) Int. Cl. B25F 5/00; B25B 21/02; B25B 23/00

(52) U.S. Cl. CPC B25F 5/001; B25B 21/02; B25B 23/0035

(57) ABSTRACT

An angle impact tool includes: a brushless motor having a stator and a rotor, which rotates around a first rotational axis relative to the stator; an impact mechanism, which is rotated by the rotor; an output shaft, which is impacted by the impact mechanism and rotates around a second rotational axis; a motor housing, which houses the brushless motor; and one or more battery-mounting parts, on which one or more battery packs is (are respectively) mounted. In a front-rear direction, which is orthogonal to the second rotational axis, the impact mechanism and the output shaft are disposed more forward than the brushless motor. The front-rear direction and the output shaft are orthogonal to each other. The maximum fastening torque of the output shaft is 500 N·m or more and less than 1,000 N·m.

### CROSS-REFERENCE TO RELATED APPLICATION

This application claims priority to Japanese patent application no. 2023-056404 filed on Mar. 30, 2023, the contents of which are fully incorporated herein by reference.

### TECHNICAL FIELD

The techniques disclosed in the present specification relate to an angle impact tool.

### BACKGROUND ART

US 2015/364972 discloses an angle impact driver.

### SUMMARY OF THE INVENTION

It is one, non-limiting object of the present teaching to disclose techniques for designing an angle impact tool to have a higher output torque for fastening (tightening) bolts, screws, etc.

In one non-limiting aspect of the present teachings, an angle impact tool may comprise: a brushless motor comprising a stator and a rotor, which rotates around a first rotational axis relative to the stator; an impact mechanism (e.g., a hammer), which is rotated by the rotor; an output shaft, which is impacted by the impact mechanism and rotates around a second rotational axis; a motor housing, which houses the brushless motor; and one or more battery-mounting parts, on which one or more battery packs is (are respectively) mounted. In a front-rear direction, which is orthogonal to the second rotational axis, the impact mechanism and the output shaft may be disposed more forward than the brushless motor. The front-rear direction and the output shaft may be orthogonal to each other. The maximum fastening torque of the output shaft may be 500 N·m or more and less than 1,000 N·m.

According to the techniques disclosed in the present specification, an angle impact tool can be designed such that the output shaft applies a higher torque.

### BRIEF DESCRIPTION OF THE DRAWINGS

FIG. 1 is a side view that shows an impact wrench according to a first embodiment of the present teachings.

FIG. 2 is a cross-sectional view that shows a portion of the impact wrench according to the first embodiment.

FIG. 3 schematically shows a stator according to the first embodiment.

FIG. 4 schematically shows an output shaft according to the first embodiment.

FIG. 5 is a side view that shows an impact wrench according to a second embodiment of the present teachings.

FIG. 6 is a side view that shows an impact wrench according to a third embodiment of the present teachings.

FIG. 7 is a side view that shows an impact wrench according to a fourth embodiment of the present teachings.

FIG. 8 is a side view that shows an impact wrench according to a fifth embodiment of the present teachings.

FIG. 9 is a front view that shows an impact wrench according to a sixth embodiment of the present teachings.

FIG. 10 is a cross-sectional view that shows a portion of an impact driver according to a seventh embodiment of the present teachings.

FIG. 11 shows the relationships among the rated voltage of a battery pack, the outer diameter of a stator core, and the maximum fastening torque of the output shaft according to the embodiments.

FIG. 12 shows an impact wrench according to another embodiment.

FIG. 13 shows an impact wrench according to another embodiment.

FIG. 14 shows an impact wrench according to another embodiment.

FIG. 15 schematically shows a portion of an angle impact tool according to another embodiment.

FIG. 16 schematically shows a motor according to another embodiment.

FIG. 17 shows a portion of an angle impact tool according to another embodiment.

### DETAILED DESCRIPTION OF THE INVENTION

As was mentioned above, an angle impact tool may comprise: a brushless motor comprising a stator and a rotor, which rotates around a first rotational axis relative to the stator; an impact mechanism (e.g., a hammer), which is rotated by the rotor; an output shaft, which is impacted by the impact mechanism and rotates around a second rotational axis; a motor housing, which houses the brushless motor; and one or more battery-mounting parts, on which one or more battery packs is (are respectively) mounted. In a front-rear direction, which is orthogonal to the second rotational axis, the impact mechanism and the output shaft may be disposed more forward than the brushless motor. The front-rear direction and the output shaft may be orthogonal to each other. The maximum fastening torque of the output shaft may be 500 N·m or more and less than 1,000 N·m.

According to the above-mentioned configuration, the output shaft of the angle impact tool can be driven (rotated) with or at a higher torque. It is noted that maximum fastening torque is the torque when fastening an object to be fastened and generally refers to the torque measured for a further fastening (tightening) torque wrench or the like with respect to the object to be fastened (tightened) after it has been fastened (tightened). It is noted that it is not a method in which measuring is performed by loosening a nut or a bolt. Typically, maximum fastening torque is listed in the catalogs of respective manufacturers.

In one or more embodiments, the rated voltage of the battery pack(s) may be 18 V or more. The outer diameter of the stator may be 50 mm or more. The maximum output of the brushless motor may be 400 W or more. The rotational speed of the output shaft may be 1.00 rpm or more and 4,000 rpm or less. The impact rate of the impact mechanism may be 1,250 ipm or more and 5,000 ipm or less. The weight (mass) of a hammer of the impact mechanism may be 160 g or more and 640 g or less. The speed-reduction ratio of the speed-reducing mechanism may be 1/18.0 or more and 1/4.5 or less. The distance between a first side and a second side, which oppose each other, of the tip portion of the output shaft may be ½ inch (1.27 cm) or more and 2.5 inches (6.35 cm) or less.

According to the above-mentioned configuration, the maximum fastening torque of the output shaft can be made to be 500 N·m or more.

In one or more embodiments, an angle impact tool may comprise: a brushless motor comprising a stator and a rotor, which rotates around a first rotational axis relative to the stator; an impact mechanism, which is rotated by the rotor; an output shaft, which is impacted by the impact mechanism and rotates around a second rotational axis; a motor housing, which houses the brushless motor; and one or more battery-mounting parts, on which one or more battery packs is (are respectively) mounted. In a front-rear direction, which is orthogonal to the second rotational axis, the impact mechanism and the output shaft may be disposed more forward than the brushless motor. The front-rear direction and the output shaft may be orthogonal to each other. The maximum fastening torque of the output shaft may be 1,000 N·m or more and less than 1,500 N·m.

According to the above-mentioned configuration, the output shaft of the angle impact tool can be driven (rotated) with or at a higher torque.

In one or more embodiments, the rated voltage of the battery pack(s) may be 18 V or more. The outer diameter of the stator may be 50 mm or more. The maximum output of the brushless motor may be 500 W or more. The rotational speed of the output shaft may be 800 rpm or more and 3,200 rpm or less. The impact rate of the impact mechanism may be 1,100 ipm or more and 4,400 ipm or less. The weight (mass) of a hammer of the impact mechanism may be 310 g or more and 1,240 g or less. The speed-reduction ratio of the speed-reducing mechanism may be 1/20.0 or more and 1/5.0 or less. The distance between a first side and a second side, which oppose each other, of the tip portion of the output shaft may be ½ inch (1.27 cm) or more and 2.5 inches (6.35 cm) or less.

According to the above-mentioned configuration, the maximum fastening torque of the output shaft can be made to be 1,000 N·m or more.

In one or more embodiments, an angle impact tool may comprise: a brushless motor comprising a stator and a rotor, which rotates around a first rotational axis relative to the stator; an impact mechanism, which is rotated by the rotor; an output shaft, which is impacted by the impact mechanism and rotates around a second rotational axis; a motor housing, which houses the brushless motor; and one or more battery-mounting parts, on which one or more battery packs is (are respectively) mounted. In a front-rear direction, which is orthogonal to the second rotational axis, the impact mechanism and the output shaft may be disposed more forward than the brushless motor. The front-rear direction and the output shaft may be orthogonal to each other. The maximum fastening torque of the output shaft may be 1,500 N·m or more and less than 3,000 N·m.

According to the above-mentioned configuration, the output shaft of the angle impact tool can be driven (rotated) with or at a higher torque.

In one or more embodiments, the rated voltage of the battery pack(s) may be 18 V or more. The outer diameter of the stator may be 50 mm or more. The maximum output of the brushless motor may be 650 W or more. The rotational speed of the output shaft may be 900 rpm or more and 3,600 rpm or less. The impact rate of the impact mechanism may be 1,250 ipm or more and 5,000 ipm or less. The weight (mass) of a hammer of the impact mechanism may be 265 g or more and 1,060 g or less. The speed-reduction ratio of the speed-reducing mechanism may be 1/30.0 or more and 1/7.5 or less. The distance between a first side and a second side, which oppose each other, of the tip portion of the output shaft may be ¾ inch (1.905 cm) or more and 2.5 inches (6.35 cm) or less.

According to the above-mentioned configuration, the maximum fastening torque of the output shaft can be made to be 1,500 N·m or more.

In one or more embodiments, the angle impact tool may comprise a gear mechanism, into which rotation from the impact mechanism is input. The output shaft may be rotated by the rotation input from the gear mechanism.

According to the above-mentioned configuration, the rotational force of the motor is transmitted, in order, to the impact mechanism, the gear mechanism, and the output shaft. It is noted that the gear mechanism may reduce the rotational speed of the impact mechanism. The gear mechanism may comprise a planetary-gear mechanism or may comprise a bevel gear.

In one or more embodiments, the angle impact tool may comprise a gear mechanism, into which rotation from the rotor is input. The impact mechanism may be rotated by the rotation input from the gear mechanism.

According to the above-mentioned configuration, the rotational force of the motor is transmitted, in order, to the gear mechanism, the impact mechanism, and the output shaft. It is noted that the gear mechanism may reduce or may increase the rotational speed of the motor. The gear mechanism may comprise a planetary-gear mechanism or may comprise a bevel gear.

Embodiments according to the present disclosure are explained below, with reference to the drawings, but the present disclosure is not limited to the embodiments. Structural elements of the embodiments explained below can be combined where appropriate. In addition, there are also situations in which some of the structural elements are not used.

In the embodiments, positional relationships among parts are explained using the terms “left,” “right,” “front,” “rear,” “up,” and “down.” These terms indicate relative positions or directions, with the center of an impact wrench as the reference. A left-right direction, a front-rear direction, and an up-down direction are all mutually orthogonal.

It is noted that, in the embodiments, 1 N·m, which is a unit of torque, can be converted to 0.7376 ft-lb, and 1 ft-lb can be converted to 1.36 N·m.

### First Embodiment

A first embodiment will now be explained.

### Impact Wrench

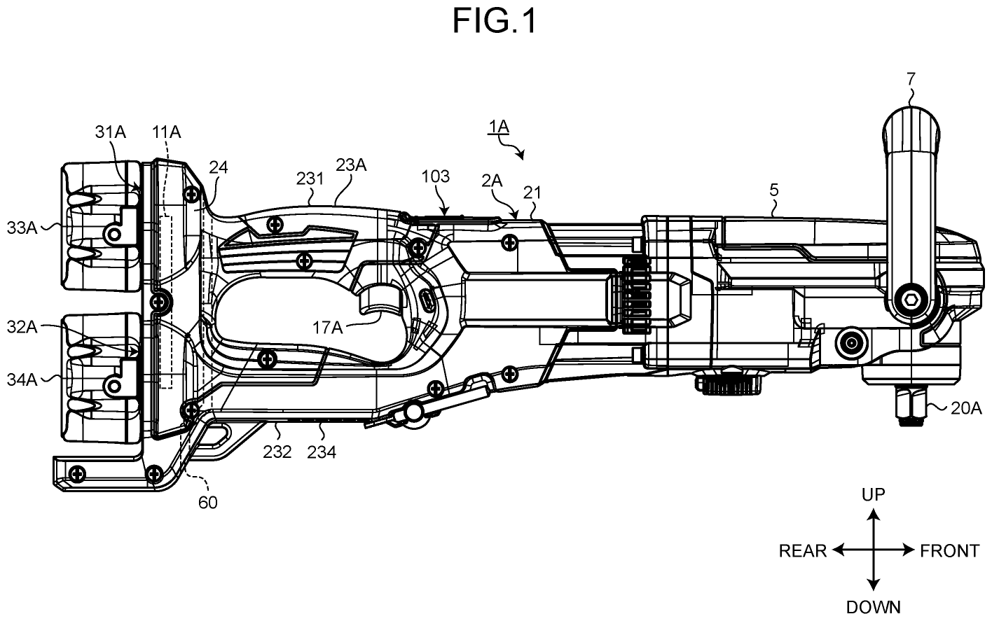

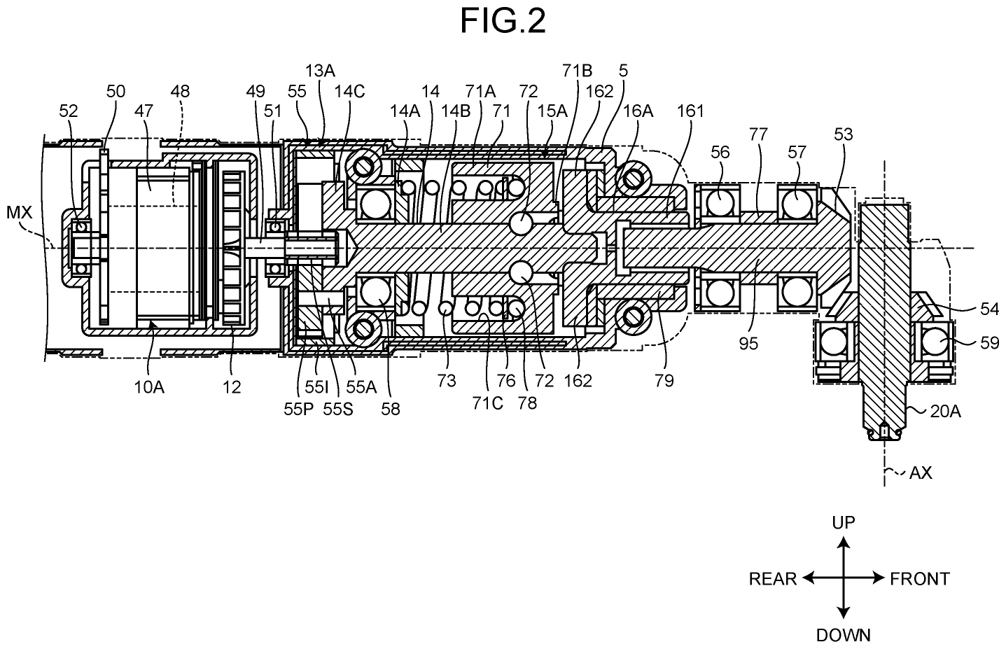

FIG. 1 is a side view that shows an impact wrench 1A according to the first embodiment of the present teachings. FIG. 2 is a cross-sectional view that shows a portion of the impact wrench 1A according to the first embodiment. The impact wrench 1A is an angle impact wrench, which is one type of angle impact tool.

The impact wrench 1A comprises a main-body housing 2A, a gear housing 5, a handle 7, a first battery-mounting part 31A, a second battery-mounting part 32A, a motor 10A, a controller 11A, a fan 12, a speed-reducing mechanism (torque-increasing mechanism) 13A, a spindle 14, an impact mechanism 15A, an anvil 16A, an intermediate shaft 95, an output shaft 20A, and a trigger switch 17A.

The main-body housing 2A houses at least the motor 10A. The main-body housing 2A comprises a motor housing 21, a grip housing 23A, and a controller housing 24.

The motor housing 21 houses the motor 10A. The grip housing 23A is disposed more rearward than the motor housing 21. The grip housing 23A is connected to a rear portion of the motor housing 21. The grip housing 23A is configured to be gripped (held) by a user. In the present embodiment, the grip housing 23A comprises a first grip part (handle) 231 and a second grip part 232 (support part 234), which is disposed more downward than the first grip part 231. The trigger switch 17A is disposed on the first grip part 231.

The controller housing 24 houses the controller 11A. A rear-end portion of the first grip part 231 and a rear-end portion of the second grip part 232 are each connected to the controller housing 24.

The gear housing 5 is disposed more forward than the motor housing 21. The gear housing 5 houses the speed-reducing mechanism 13A, the spindle 14, the impact mechanism 15A, the anvil 16A, and the intermediate shaft 95. The gear housing 5 houses a portion of the output shaft 20A.

The handle 7 is configured to be gripped by the user and preferably has a loop-shape. The handle 7 is provided such that it protrudes upward from the gear housing 5 and is pivotable relative to the gear housing 5 and motor housing 21. The loop-shape of the handle 7 provides a convenient shape for pivotably attaching the handle 7 to the main-body housing 2A and for grasping by the user. In addition, the loop-shape may be desirable in situations in which the impact wrench 1A is particularly heavy. In this case, a rope or other supporting material may be tied to, or looped around, the loop-shaped handle 7 and attached to or looped around a support structure above the impact wrench 1A so that the impact wrench 1A may be suspended above a workpiece, thereby reducing the weight that has to be borne by the user of the impact wrench 1A during a fastening operation.

In the front-rear direction, the impact mechanism 15A, the anvil 16A, and the output shaft 20A are disposed more forward than the motor 10A. The grip housing 23A is disposed more rearward than the motor 10A.

The first battery-mounting part 31A and the second battery-mounting part 32A are each provided rearward of the controller housing 24. In the present embodiment, the first battery-mounting part 31A is disposed more upward than the second battery-mounting part 32A.

A first battery pack 33A is mounted on the first battery-mounting part 31A. The first battery pack 33A is detachable from the first battery-mounting part 31A.

The first battery-mounting part 31A comprises terminals. By mounting the first battery pack 33A on the first battery-mounting part 31A, battery terminals, which also may be called connection terminals, of the first battery pack 33A are electrically connected to the corresponding terminals of the first battery-mounting part 31A.

A second battery pack 34A is mounted on the second battery-mounting part 32A. The second battery pack 34A is detachable from the second battery-mounting part 32A.

The second battery-mounting part 32A has terminals. By mounting the second battery pack 34A on the second battery-mounting part 32A, the battery terminals, which also may be called connection terminals, of the second battery pack 34A and the corresponding terminals of the second battery-mounting part 32A are electrically connected to each other.

The first battery pack 33A and the second battery pack 34A each function as a power supply of the impact wrench 1A. The first battery pack 33A preferably comprises a secondary battery. In the present embodiment, the first battery pack 33A preferably comprises a rechargeable lithium-ion battery (e.g., a plurality lithium-ion battery cells that are electrically connected to each other). The second battery pack 34A also preferably comprises a secondary battery. In the present embodiment, the second battery pack 34A also preferably comprises a rechargeable lithium-ion battery (e.g., a plurality lithium-ion battery cells that are electrically connected to each other). When mounted on the first battery-mounting part 31A, the first battery pack 33A can supply electric power to the impact wrench 1A. When mounted on the second battery-mounting part 32A, the second battery pack 34A can supply electric power to the impact wrench 1A. The motor 10A is driven by the electric power supplied from both the first battery pack 33A and the second battery pack 34A. The controller 11A operates using the electric power supplied from both the first battery pack 33A and the second battery pack 34A. Preferably, one or more elastic (cushioning) members 60 is (are respectively) disposed between the motor 10A and the one or more battery-mounting parts 31A. The elastic (cushioning) member(s) 60 serve(s) as vibration attenuation member(s) (vibration isolation member(s)) that absorb(s) and attenuate(s) vibrations generated by the motor 10A and/or by the impact mechanism 15A striking/impacting the anvil 16A. The elastic member(s) 60 may be, e.g., composed of an elastomeric material, such as, e.g., rubber (natural or synthetic) or polyurethane, or another material capable of effectively absorbing vibration. In any of the embodiments described herein, the elastic member(s) 60 may be in the form of a piece of elastomer member (e.g., flat shaped, block-shaped, gasket-shaped, etc.) and/or the elastic member(s) 60 may include one or more spring(s), e.g., in the form of compression springs, leaf springs, etc. The spring(s) may be composed of a metal, if desired. For example, one or more of the elastic (cushioning) member(s) may be formed, e.g., as disclosed in US 2023/0026934 A1 and/or as springs, e.g., as disclosed in US 2023/0121902 A1. The contents of US 2023/0026934 A1 and US 2023/0121902 A1 are incorporated herein by reference as if fully set forth herein.

The rated voltage of the first battery pack 33A and the rated voltage of the second battery pack 34A are preferably equal to each other. The rated voltage of the first battery pack 33A and the rated voltage of the second battery pack 34A may be, e.g., 18 V or 36 V, or e.g., any voltage value between 18-36V. The outer shape and the dimensions of the first battery pack 33A are preferably the same as the outer shape and the dimensions of the second battery pack 34A. That is, the type of the first battery pack 33A and the type of the second battery pack 34A are preferably the same. However, it is, of course, possible to design the battery-mounting parts 31A, 32A such that battery packs having one or more of different rated voltages, different outer shapes, different dimensions, etc. may be mounted thereon.

The structure and the size of the terminals of the first battery-mounting part 31A are preferably the same as the structure and the size of the terminals of the second battery-mounting part 32A. But again, it is, of course, possible to design the battery-mounting parts 31A, 32A such that battery packs having one or more of different shapes and/or sizes of the terminals, etc. may be mounted thereon.

The motor 10A functions as a motive power supply (source) of the impact wrench 1A. The motor 10A is preferably an inner-rotor-type DC brushless motor, although other types of motors may be utilized with the present teachings, such as an outer-rotor-type DC brushless motor or a DC brushed motor. The motor 10A is housed in the main-body housing 2A.

The motor 10A comprises a stator 47, a rotor 48, and a rotor shaft 49. At least a portion of the rotor 48 is disposed in the interior of the stator 47. Thus, the stator 47 is disposed around the rotor 48. The rotor shaft 49 is fixed to the rotor 48. The rotor 48 is rotatable relative to the stator 47 around motor rotational axis MX, which extends in the front-rear direction. The brushless motor 10A is preferably configured to output a motor torque of 2.0 N·m or more and 11.0 N·m or less, and to rotate the rotor 48 at a rotational speed of 3,000 rpm or more and 4,300 rpm or less.

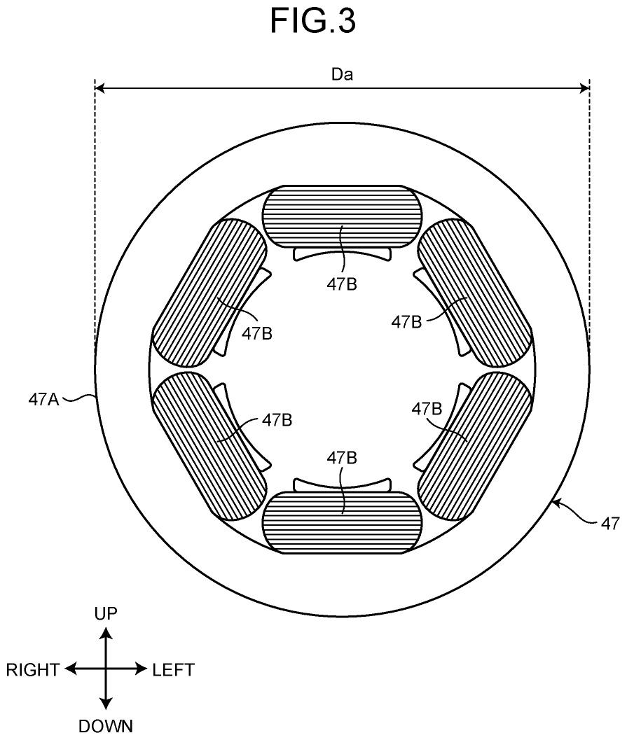

FIG. 3 schematically shows the stator 47 according to the first embodiment. The stator 47 comprises: a stator core 47A, which has a plurality of teeth; and coils 47B, which are wound through (around) insulators and respectively around the teeth of the stator core 47A. Pairs of the coils 47B are respectively electrically connected to each other via a busbar unit (short-circuiting members).

The outer shape of the stator core 47A is substantially a circular shape. The stator core 47A is formed such that outer diameter Da of the stator core 47A is a stipulated value. The stator core 47A is composed of a plurality of stacked steel plates that are laminated together. The length of the stacked steel plates in a direction parallel to the rotational axis AX of the rotor is 24 mm or more.

As shown in FIG. 2, the rotor 48 rotates around motor rotational axis AX, which extends in the front-rear direction. The rotor 48 comprises a rotor core and one or more rotor magnets, which is (are) fixed to the rotor core. Preferably, the number of rotor magnets in the rotor core is greater than the number of teeth on the stator core 47A. The rotor magnets preferably (each) have a residual magnetic flux density of 1.32 T or more. In addition or in the alternative, the rotor magnets preferably have a coercive force of 971 kA/m or more.

A sensor board 50 is fixed to one of the insulators of the stator 47. The sensor board 50 detects the position of the rotor 48 in the rotational direction. The sensor board 50 comprises rotation-detection devices, which are supported on a ring-shaped circuit board. The rotation-detection devices detect the position of the rotor 48 in the rotational direction by detecting the position(s) of the rotor magnet(s) of the rotor 48.

The rotor shaft 49 is fixed to the rotor core of the rotor 48. The rotor 48 and the rotor shaft 49 rotate together around motor rotational axis MX.

The rotor shaft 49 is supported in a rotatable manner in (by) a first rotor bearing 51 and a second rotor bearing 52. The first rotor bearing 51 rotatably supports a front portion of the rotor shaft 49, which protrudes more forward than a front-end surface of the rotor 48. The second rotor bearing 52 rotatably supports a rear portion of the rotor shaft 49, which protrudes more rearward than a rear-end surface of the rotor 48. The first rotor bearing 51 is held on (in, by) the gear housing 5.

A sun gear 55S is fixed to a front-end portion of the rotor shaft 49. The sun gear 55S is coupled to at least a portion of the speed-reducing mechanism 13A, as will be further discussed below. The rotor shaft 49 is coupled to the speed-reducing mechanism 13A via the sun gear 55S.

The controller 11A outputs control signals, which control the energization (driving) of the motor 10A. The controller 11A comprises a circuit board, on which a plurality of electronic parts is installed. Illustrative examples of the electronic parts installed on the circuit board include: a processor, such as a CPU (central processing unit); nonvolatile memory, such as ROM (read-only memory) and storage; volatile memory, such as RAM (random-access memory); field-effect transistors (FETs: field-effect transistors); and resistors.

The controller 11A is disposed more rearward than the motor 10A.

The fan 12 generates an airflow for cooling the motor 10A and the controller 11A. The fan 12 is disposed forward of the stator 47. The fan 12 is fixed to a front portion of the rotor shaft 49. The fan 12 is disposed between the first rotor bearing 51 and the stator 47. The fan 12 and the rotor shaft 49 rotate together.

The speed-reducing mechanism 13A transmits, to the impact mechanism 15A, the rotational force of the motor 10A via the spindle 14. The speed-reducing mechanism 13A reduces the speed of the rotation of the rotor 48 and transmits such rotation to the impact mechanism 15A. The speed-reducing mechanism 13A couples the rotor shaft 49 and the spindle 14 to each other. The speed-reducing mechanism 13A causes the spindle 14 to rotate at a rotational speed that is lower than the rotational speed of the rotor shaft 49, but at a higher torque. The speed-reducing mechanism 13A comprises a planetary-gear mechanism 55, which is driven using the rotational force of (output by) the motor 10A.

The planetary-gear mechanism 55 comprises the sun gear 55S, planet gears 55P, and an internal gear 55I. A plurality of the planet gears 55P is provided. The planet gears 55P are disposed around the sun gear 55S. The internal gear 55I is disposed around the plurality of planet gears 55P. The planetary-gear mechanism 55 is housed in the gear housing 5.

The sun gear 55S is rotatable around motor rotational axis MX, which extends in the front-rear direction. When the rotor shaft 49 rotates, the sun gear 55S rotates.

Each of the planet gears 55P meshes with the sun gear 55S. The planet gears 55P are respectively supported in a rotatable manner on the spindle 14 via pins 55A. The spindle 14 is rotated by the planet gears 55P. The internal gear 55I comprises inner teeth (radially inward facing teeth), which mesh with the planet gears 55P. The internal gear 55I is fixed to the gear housing 5. A plurality of protruding portions is provided on an outer-circumferential surface of the internal gear 55I. The protruding portions of the internal gear 55I respectively fit into recessed portions provided (defined) in an inner-circumferential surface of the gear housing 5. The internal gear 55I is always non-rotatable relative to the gear housing 5.

When the motor 10A is driven (energized) and thus causes the rotor shaft 49 and the sun gear 55S to rotate, the planet gears 55P revolve around the sun gear 55S. That is, the planet gears 55P revolve around the sun gear 55S while meshing with the inner teeth of the internal gear 55I. When the planet gears 55P revolve around the sun gear 55S, the spindle 14, which is connected to the planet gears 55P via the pins 55A, rotates at a rotational speed that is lower than the rotational speed of the rotor shaft 49 and at a torque that is higher than the torque of the rotor shaft 49.

The spindle 14 is rotated by the rotational force of the motor 10A that is transmitted by (via) the speed-reducing mechanism 13A. The spindle 14 transmits to the impact mechanism 15A the rotational force of the motor 10A transmitted via the speed-reducing mechanism 13A. The spindle 14 is rotatable around motor rotational axis MX. At least a portion of the spindle 14 is disposed forward of the speed-reducing mechanism 13A. The spindle 14 is disposed rearward of the anvil 16A.

The spindle 14 comprises a flange portion 14A, a spindle-shaft portion 14B, and a protruding part 14C. The spindle-shaft portion 14B protrudes forward from the flange portion 14A. The protruding part 14C protrudes rearward from the flange portion 14A.

The planet gears 55P are respectively supported in a rotatable manner on the flange portion 14A and the protruding part 14C via the pins 55A. The spindle 14 is supported in a rotatable manner on a spindle bearing 58. The spindle bearing 58 supports the protruding part 14C in a rotatable manner. The spindle bearing 58 is held on the gear housing 5.

The impact mechanism 15A impacts the anvil 16A in the rotational direction around motor rotational axis MX, preferably at a rate of two impacts per 3600 rotation of a hammer 71 of the impact mechanism 15A. The impact mechanism 15A is disposed forward of the motor 10A. The impact mechanism 15A is rotated by the rotor 48 of the motor 10A. The impact mechanism 15A is rotatable around motor rotational axis MX. The rotational force of the motor 10A is transmitted to the impact mechanism 15A via the speed-reducing mechanism 13A and the spindle 14. The impact mechanism 15A impacts (strikes) the anvil 16A in the rotational direction using the rotational force of the spindle 14, which is rotated by the motor 10A.

The impact mechanism 15A comprises the hammer 71, balls 72, a coil spring 73, and a washer 76.

The hammer 71 is disposed downward of the speed-reducing mechanism 13A. The hammer 71 is disposed around the spindle-shaft portion 14B. The hammer 71 is held on the spindle-shaft portion 14B. The hammer 71 is rotated by the motor 10A. The balls 72 are disposed between the spindle-shaft portion 14B and the hammer 71. The hammer 71 comprises a tube-shaped hammer body 71A and hammer-projection portions 71B, which are provided (defined) at a front portion of the hammer body 71A. A ring-shaped recessed portion (annular recess) 71C is provided (defined) in a rear surface of the hammer body 71A. The recessed portion 71C recesses forward from a rear surface of the hammer body 71A.

The hammer 71 is rotated by the motor 10A. More specifically, the rotational force of the motor 10A is transmitted to the hammer 71 via the speed-reducing mechanism 13A and the spindle 14. The hammer 71 is rotatable, together with the spindle 14, using the rotational force of the spindle 14, which is rotated by the motor 10A. The hammer 71 and the spindle 14 each rotate around motor rotational axis MX.

The washer 76 is disposed in the interior of the recessed portion 71C. The washer 76 is supported on the hammer 71 via a plurality of balls 78. The balls 78 are disposed forward of the washer 76.

The coil spring 73 is disposed around the spindle-shaft portion 14B. A rear-end portion of the coil spring 73 is supported on the flange portion 14A. A front-end portion of the coil spring 73 is disposed in the interior of the recessed portion 71C and supported on the washer 76. The coil spring 73 continuously generates an elastic force, which causes (urges) the hammer 71 to move forward.

The balls 72 are made of a metal such as steel. The balls 72 are disposed between the spindle-shaft portion 14B and the hammer 71. The spindle 14 has a spindle groove, in which at least a portion of each of the balls 72 is disposed. The spindle groove is provided in a portion of an outer surface of the spindle-shaft portion 14B. The hammer 71 has a hammer groove, in which at least a portion of each of the balls 72 is disposed. The hammer groove is provided (defined) in a portion of an inner surface of the hammer 71. The balls 72 are disposed between the spindle groove and the hammer groove. The balls 72 can roll along the inner side of the spindle groove and the inner side of the hammer groove. The hammer 71 is capable of moving along with the balls 72. The spindle 14 and the hammer 71 are capable of relative movement, within a movable range defined by the spindle groove and the hammer groove, in a direction parallel to motor rotational axis MX and in the rotational direction around motor rotational axis MX.

The anvil 16A rotates around motor rotational axis MX, which extends in the front-rear direction. At least a portion of the anvil 16A is disposed forward of the hammer 71. The anvil 16A is impacted (struck) in the rotational direction by the hammer 71 of the impact mechanism 15A. A front-end portion of the spindle-shaft portion 14B is disposed in an anvil-recessed portion, which is provided in a rear-end portion of the anvil 16A.

The anvil 16A comprises an anvil-shaft portion 161 and anvil-projection portions 162. The anvil-shaft portion 161 is disposed forward of the impact mechanism 15A. The anvil-projection portions 162 protrude radially outward of the anvil-shaft portion 161 from (at) a rear-end portion of the anvil-shaft portion 161. The anvil-projection portions 162 are impacted by the impact mechanism 15A in the rotational direction and thus rotated around motor rotational axis MX.

The anvil 16A is supported in (by) an anvil bearing 79 in a rotatable manner. The anvil bearing 79 is disposed around the anvil-shaft portion 161. The anvil 16A is rotatable around motor rotational axis MX. In the present embodiment, the anvil bearing 79 is a slide bearing. The anvil bearing 79 has a tube shape. In the present embodiment, a sleeve is used as the anvil bearing 79. It is noted that the slide bearing may be formed by, for example, impregnating a tube-shaped porous-metal body, which is manufactured using a powder-metallurgy method, with a lubricating oil.

A rear-end portion of the intermediate shaft 95 is splined to (with) the anvil 16A. The intermediate shaft 95 rotates, together with the anvil 16A, around motor rotational axis MX. A rear portion of the intermediate shaft 95 is supported by a first shaft bearing 56 in a rotatable manner. A front portion of the intermediate shaft 95 is supported by a second shaft bearing 57 in a rotatable manner. A spacer 77 is disposed between the first shaft bearing 56 and the second shaft bearing 57.

A first bevel gear 53 is provided at a front-end portion of the intermediate shaft 95. A second bevel gear 54 is fixed to the output shaft 20A. The first bevel gear 53 and the second bevel gear 54 mesh with each other.

The output shaft 20A is rotatable around output rotational axis AX, which extends in the up-down direction. The output shaft 20A is supported in a rotatable manner by a shaft bearing 59. The rotational force of the intermediate shaft 95 is transmitted to the output shaft 20A via the first bevel gear 53 and the second bevel gear 54. The output shaft 20A is rotated by the rotation of the intermediate shaft 95.

When the hammer 71 impacts the anvil 16A, the impact force from the hammer 71 that was input to the anvil 16A is transmitted to the output shaft 20A via the intermediate shaft 95. The output shaft 20A is impacted by the impact mechanism 15A via the intermediate shaft 95 and the anvil 16A.

A lower-end portion of the output shaft 20A is disposed downward of the gear housing 5 through an opening provided in a lower portion of a front portion of the gear housing 5. A socket, which serves as a tool accessory, is mounted on the lower-end portion of the output shaft 20A.

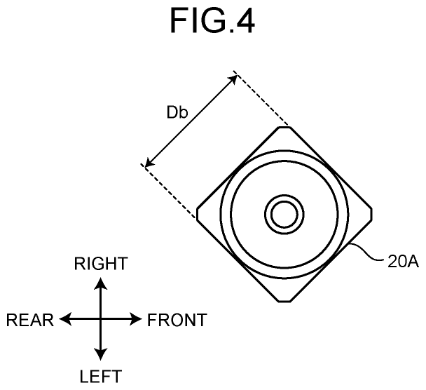

FIG. 4 schematically shows the output shaft 20A according to the first embodiment. The socket is mounted on the lower-end portion (tip portion) of the output shaft 20A. The tip portion of the output shaft 20A, on which the socket is mounted, is substantially a square-columnar shape. The output shaft 20A is formed such that distance Db between the first side and the second side, which oppose each other across output rotational axis AX, of the tip portion of the output shaft 20A is a stipulated value. Distance Db is the distance between the first side and the second side within a plane orthogonal to output rotational axis AX. Distance Db may be considered to be the length of one side of the output shaft 20A within a plane orthogonal to output rotational axis AX.

The trigger switch 17A is configured to be manipulated (pressed, squeezed) by the user to drive (energize) the motor 10A. Driving of the motor 10A means that the coils 47B of the stator 47 are energized and thereby the rotor 48 rotates. The trigger switch 17A is provided on the first grip part 231. By manipulating (pressing) the trigger switch 17A such that it moves upward, the motor 10A is driven. By releasing the trigger switch 17A, the drive of the motor 10A stops.

### Operation of Impact Wrench

Next, the operation of the impact wrench 1A will be explained. For example, when fastening work is to be performed on a work object, the socket to be used in the fastening work is mounted on the lower-end portion of the output shaft 20A. After the socket has been mounted on the output shaft 20A, the user grips the grip housing 23A with their hand(s) and manipulates (presses) the trigger switch 17A such that the trigger switch 17A moves upward. When the trigger switch 17A is manipulated, electric power is supplied from the first battery pack 33A and the second battery pack 34A to the motor 10A, and thereby the motor 10A is driven. The rotor 48 and the rotor shaft 49 are thus rotated by the motor 10A. When the rotor shaft 49 rotates, the rotational force of the rotor shaft 49 is transmitted to the planet gears 55P via the sun gear 55S. In the state in which the planet gears 55P mesh with the inner teeth of the internal gear 55I, the planet gears 55P revolve around the sun gear 55S while rotating around the respective pins 55A, because the planet gears 55P are supported in a rotatable manner on the spindle 14 via the pins 55A. Owing to the revolving of the planet gears 55P, the spindle 14 rotates at a rotational speed that is lower than the rotational speed of the rotor shaft 49.

When the spindle 14 rotates in the state in which the hammer-projection portions 71B and the anvil-projection portions 162 are in contact with each other, the anvil 16A rotates together with the hammer 71 and the spindle 14. Owing to the rotation of the anvil 16A, the intermediate shaft 95 and the output shaft 20A each rotate, and the fastening work advances.

In the situation in which, as a result of the advancement of the fastening (tightening) work, a load that is greater than or equal to a prescribed value acts on the anvil 16A via the output shaft 20A and the intermediate shaft 95, the rotation of the anvil 16A and the hammer 71 momentarily stops. Thus, as the spindle 14 continues to rotate while the rotation of the hammer 71 is stopped, the hammer 71 moves rearward. When the hammer 71 moves rearward relative to the spindle 14, the hammer-projection portions 71B no longer contact the anvil-projection portions 162. The rearwardly-moved hammer 71 then moves forward while rotating owing to the elastic force of the coil spring 73. When the hammer 71 has moved forward again while rotating, the anvil 16A is impacted in the rotational direction by the hammer 71. Thereby, the anvil 16A rotates around motor rotational axis MX with (at) higher torque, and the output shaft 20A rotates around output rotational axis AX with (at) higher torque. Consequently, a bolt or nut can be fastened with (at) higher torque.

### Specifications

In the present (first) embodiment, the maximum fastening torque of the output shaft 20A is 500 N·m or more. The maximum fastening torque of the output shaft 20A may be 500 N·m or more and less than 1,000 N·m.

The specifications of the impact wrench 1A according to the present embodiment are as below.
Maximum fastening torque of output shaft: 500 N·m or more and 1,000 N·m or less
Sum total of rated voltages of battery pack(s): 36 V or more
Outer diameter Da of stator core: 50 mm
Maximum output of motor: 400 W
Rotational speed of output shaft (during no-load): 2,000 rpm
Impact rate of impact mechanism: 2,500 ipm
Speed-reduction ratio of speed-reducing mechanism: 1/30
Weight (mass) of hammer: 320 g
Distance Db between first side and second side of tip portion of output shaft: ½ inch (1.27 cm)
External dimensions of impact wrench when battery pack(s) is (are) not mounted: 538 mm (front-rear direction)×128 mm (left-right direction)×223 mm (up-down direction)
Weight (mass) of impact wrench when battery pack(s) is (are) not mounted: 3 kg

One or more battery packs having a rated voltage of 18 V should be mounted on the impact wrench 1A such that the sum total of the rated voltage(s) of the battery pack(s) is 18 V or more. It is noted that, in the present embodiment, the first battery pack 33A and the second battery pack 34A, each having a rated voltage of 18 V, are mounted on the impact wrench 1A, and thus the sum total of the rated voltages of the battery pack(s) is 36 V.

### Effects

In the first embodiment as explained above, the impact wrench 1A comprises: the motor 10A, which is a brushless motor, comprising the stator 47 and the rotor 48, that rotates around motor rotational axis MX relative to the stator 47; the impact mechanism 15A, which is rotated by the rotor 48; the output shaft 20A, which is impacted by the impact mechanism 15A and rotates around output rotational axis AX; the motor housing 21, which houses the motor 10A; and the battery-mounting parts 31A, 32A, on which the battery packs (33A, 34A) are respectively mounted. In the front-rear direction, which is orthogonal to output rotational axis AX, the impact mechanism 15A and the output shaft 20A are disposed more forward than the motor 10A. The maximum fastening torque of the output shaft 20A is 500 N·m or more and less than 1,000 N·m.

According to the above-mentioned configuration, the output shaft 20A of the impact wrench 1A can be driven (rotated) with or at a higher torque.

In the first embodiment, the sum total of the rated voltages of the battery pack 33A is 18 V or more. Outer diameter Da of the stator core 47A is 50 mm or more. The maximum output of the motor 10A is 400 W or more. The rotational speed of the output shaft 20A after being reduced by the speed-reducing mechanism 13A is 1,000 rpm or more and 4,000 rpm or less. The impact rate of the impact mechanism 15A is 1,250 ipm or more and 5,000 ipm or less. The weight (mass) of the hammer 71 of the impact mechanism 15A is 160 g or more and 640 g or less. The speed-reduction ratio of the speed-reducing mechanism 13A is 1/18.0 or more and 1/4.5 or less. The distance Db between the first side and the second side, which oppose each other, of the tip portion of the output shaft 20A is ½ inch (1.27 cm) so more and 2.5 inches (6.35 cm) or less.

According to the above-mentioned configuration, the maximum fastening torque of the output shaft 20A can be made to be 500 N·m or more.

### Second Embodiment

A second embodiment will now be explained. In the explanation below, structural elements that are identical or equivalent to those in the embodiment described above are assigned the same symbols, and explanations of those structural elements are abbreviated or omitted.

### Impact Wrench

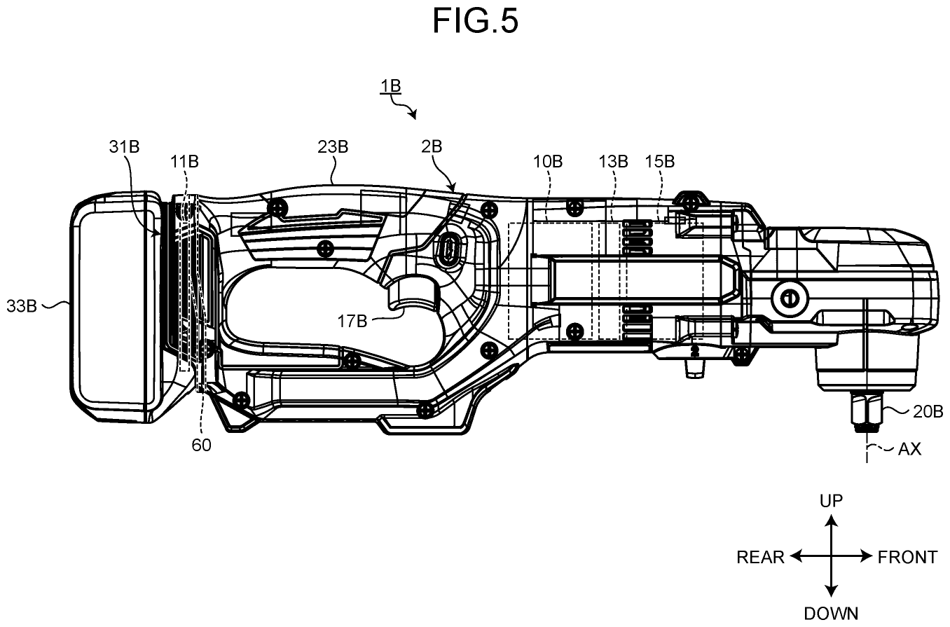

FIG. 5 is a side view that shows an impact wrench 1B according to the second embodiment. The impact wrench 1B according to the present embodiment is a modified example of the impact wrench 1A according to the first embodiment described above.

The impact wrench 1B comprises: a main-body housing 2B, which comprises a grip housing 23B; the battery-mounting part 31B; a motor 10B; a controller 11B; a speed-reducing mechanism 13B; an impact mechanism 15B; an output shaft 20B; and a trigger switch 17B.

In the present embodiment, the impact wrench 1B comprises the one battery-mounting part 31B. A battery pack 33B is mounted on the battery-mounting part 31B. The battery pack 33B is detachable from the battery-mounting part 31B. Similar to the first embodiment described above, one or more elastic members 60 is (are respectively) disposed between the motor and the battery-mounting part 31B to serve as vibration attenuation member(s) (vibration isolation member(s)).

The rated voltage of the battery pack 33B may be 18 V, 36 V, or 72 V, or any value between 18-72V.

### Specifications

In the second embodiment, the maximum fastening torque of the output shaft 20B is 500 N·m or more. The maximum fastening torque of the output shaft 20B may be 500 N·m or more and less than 1,000 N·m.

The specifications of the impact wrench 1B according to the present embodiment are as below.
Maximum fastening torque of output shaft: 500 N·m or more and less than 1,000 N·m
Rated voltage of battery pack: 18 V or more
Outer diameter Da of stator core: 50 mm
Maximum output of motor: 400 W
Rotational speed of output shaft (during no-load): 2,000 rpm
Impact rate of impact mechanism: 2,500 ipm
Speed-reduction ratio of speed-reducing mechanism: 1/9
Weight (mass) of hammer: 320 g
Distance Db between first side and second side of tip portion of output shaft: ½ inch (1.27 cm)
External dimensions of impact wrench when battery pack is not mounted: 538 mm (front-rear direction)×128 mm (left-right direction)×223 mm (up-down direction)
Weight (mass) of impact wrench when battery pack is not mounted: 3 kg

One or more battery packs, each having a rated voltage of 18 V, should be mounted on the impact wrench 1B such that the sum total of the rated voltage(s) of the battery pack(s) becomes 18 V or more. It is noted that, in the present embodiment, the battery pack 33B, which has a rated voltage of 18 V, is mounted on the impact wrench 1, and thus the sum total of the rated voltage(s) of the battery pack(s) is 18 V.

### Third Embodiment

A third embodiment will now be explained. In the explanation below, structural elements that are identical or equivalent to those in the embodiment described above are assigned the same symbols, and explanations of those structural elements are abbreviated or omitted.

### Impact Wrench

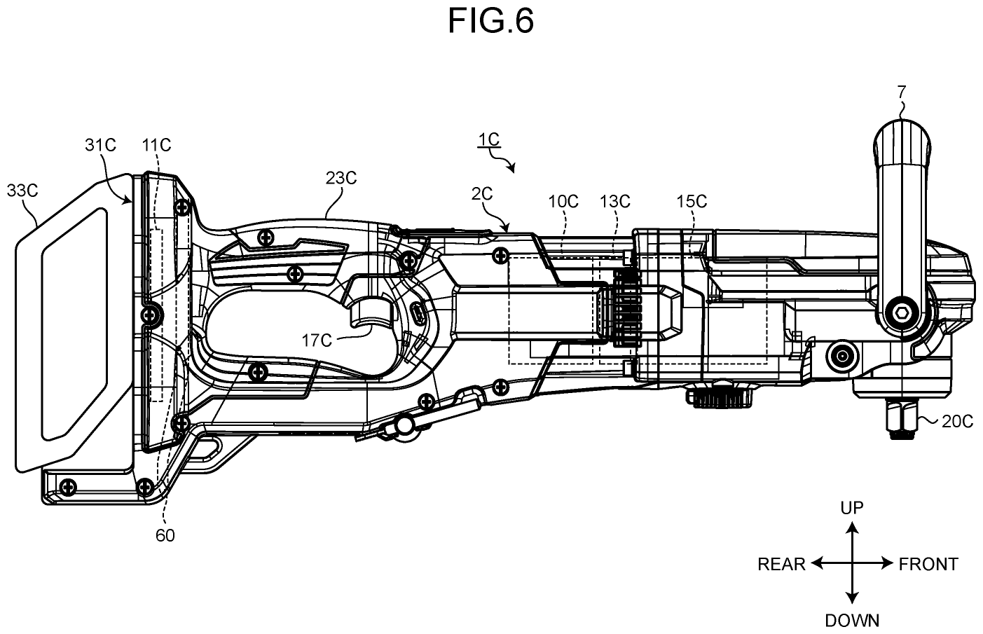

FIG. 6 is a side view that shows an impact wrench 1C according to the third embodiment. The impact wrench 1C according to the present embodiment is a modified example of the impact wrench 1A according to the first embodiment described above.

The impact wrench 1C comprises: a main-body housing 2C, which comprises a grip housing 23C; a battery-mounting part 31C; a motor 10C; a controller 11C; a speed-reducing mechanism 13C; an impact mechanism 15C; an output shaft 20C; and a trigger switch 17C.

In the present (third) embodiment, the impact wrench 1C comprises the one battery-mounting part 31C. A battery pack 33C is mounted on the battery-mounting part 31C. The battery pack 33C is detachable from the battery-mounting part 31C. Similar to the first embodiment described above, one or more elastic members 60 is (are respectively) disposed between the motor and the battery-mounting part 31C to serve as vibration attenuation member(s) (vibration isolation member(s)).

The rated voltage of the battery pack 33C may be 18 V, 36 V, or 72 V, or any value between 18-72V.

### Specifications

In the present (third) embodiment, the maximum fastening torque of the output shaft 20C is 1,000 N·m or more. The maximum fastening torque of the output shaft 20C may be 1,000 N·m or more and less than 1,500 N·m.

The specifications of the impact wrench 1C according to the present embodiment are as below.
Maximum fastening torque of output shaft: 1,000 N·m or more and less than 1,500 N·m
Rated voltage of battery pack: 18 V or more
Outer diameter Da of stator core: 50 mm
Maximum output of motor: 500 W
Rotational speed of output shaft (during no-load): 1,600 rpm
Impact rate of impact mechanism: 2,200 ipm
Speed-reduction ratio of speed-reducing mechanism: 1/10
Weight (mass) of hammer: 620 g
Distance Db between first side and second side of tip portion of output shaft: ½ inch (1.27 cm)
External dimensions of impact wrench when battery pack is not mounted: 538 mm (front-rear direction)×128 mm (left-right direction)×223 mm (up-down direction)
Weight (mass) of impact wrench when battery pack is not mounted: 4 kg

One or more battery packs, each having a rated voltage of 18 V, should be mounted on the impact wrench 1C such that the sum total of the rated voltage(s) of the battery pack(s) becomes 18 V or more. It is noted that, in the present embodiment, a battery pack 33C, which has a rated voltage of 72 V (max. 80 V), is preferably mounted on the impact wrench 1C. In this case, the sum total of the rated voltage(s) of the battery pack(s) is 72 V.

### Effects

In the third embodiment as explained above, the rated voltage of the battery pack 33C is 18 V or more. The outer diameter of the stator core is 50 mm or more. The maximum output of the motor 10C, which is a brushless motor, is 500 W or more. The rotational speed of the output shaft 20C after the rotational speed has been reduced by the speed-reducing mechanism 13C is 1,600 rpm. The impact rate of the impact mechanism 15C is 2,200 ipm. The weight (mass) of the hammer of the impact mechanism 15C is 620 g. The speed-reduction ratio of the speed-reducing mechanism 13C is 1/10. Distance Db between the first side and the second side, which oppose each other, of the tip portion of the output shaft 20C is ½ inch (1.27 cm) or more and 2 inch (2.54 cm) or less.

According to the above-mentioned configuration, the maximum fastening torque of the output shaft 20C can be made to be 1,000 N·m or more.

### Fourth Embodiment

A fourth embodiment will now be explained. In the explanation below, structural elements that are identical or equivalent to those in the embodiment described above are assigned the same symbols, and explanations of those structural elements are abbreviated or omitted.

### Impact Wrench

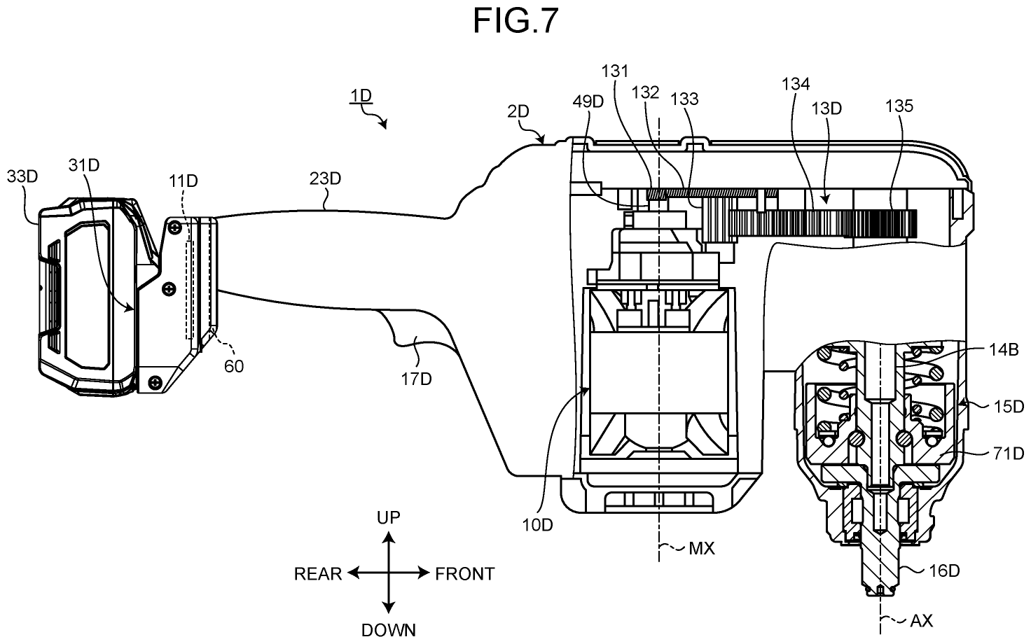

FIG. 7 is a side view that shows an impact wrench 1D according to the fourth embodiment.

The impact wrench 1D comprises: a main-body housing 2D, which comprises a grip housing 23D; a battery-mounting part 31D; a motor 10D; a controller 11D; a speed-reducing mechanism 13D; a spindle shaft portion 14B; an impact mechanism 15D; an anvil 16D, which serves at the output shaft; and a trigger switch 17D.

In the present (fourth) embodiment, the rotor shaft 49D of the motor 10D rotates around motor rotational axis MX, which extends in the up-down direction. A lower-end of the spindle shaft portion 14B is connected to the anvil 16D. Both of the spindle shaft portion 14B and the anvil 16D, which together constitute the output shaft, rotate around output rotational axis AX, which also extends in the up-down direction. That is, motor rotational axis MX and output rotational axis AX are at least substantially parallel to each other, preferably parallel. The impact mechanism 15A and the anvil 16D are disposed more forward than the motor 10A. The grip housing (handle) 23D is disposed more rearward than the motor 10D. A socket is mounted at (on) a lower-end portion of the anvil 16D.

The rotational force of the rotor shaft 49D is transmitted via the speed-reduction mechanism 13D to the spindle shaft portion 14B. The speed-reduction mechanism 13D includes: a first gear 131, which is fixed to the rotor shaft 49D; a second gear 132, which meshes with the first gear 131; a third gear, which rotates together with the second gear 132; a fourth gear 134, which is meshes with the third gear 133; and a fifth gear 135, which is meshes with the fourth gear 134. The center (rotational) axis of the rotor shaft 49D and the center (rotational) axis of the first gear 131 coincide with each other. The center (rotational) axis of the fifth gear 135 and the center (rotational) axis of the spindle shaft portion 14B coincide with each other. The fifth gear 135 is fixedly attached (connected) to the spindle shaft portion 14B so that the fifth gear 135 and the spindle shaft portion 14B rotate together.

The third gear 133 protrudes downward from a lower surface of the second gear 132. The third gear 133 is fixed to the second gear 132 in the rotational direction. The third gear 133 and the second gear 132 may be integrally formed (i.e. in one piece without a seam or break therebetween). Thus, the second gear 132 and the third gear 133 may be formed as a single member (structure).

The diameter of the first gear 131 is smaller than the diameter of the second gear 132. The diameter of the fourth gear 134 is greater than the diameter of the third gear 133. The diameter of the fifth gear 135 is smaller than the diameter of the fourth gear 134. The rotational force is transmitted to the fifth gear 134 via the first, second, third, fourth gears 131 to 134. Thus, the fifth gear 135 is (ultimately) rotated by the rotational force of the rotor shaft 49D. When the fifth gear 135 rotates, the spindle shaft portion 14B also rotates.

The hammer 71D of the impact mechanism 15D is rotated by the rotational force that is output from the motor 10D and then reduced an transmitted via at least four gear elements, i.e., via the first to fifth gears 131 to 135.

In the present embodiment, the impact wrench 1D comprises the one battery-mounting part 31D. The battery-mounting part 31D is disposed at a rear portion of the grip housing 23D. A battery pack 33D is mounted on the battery-mounting part 31D. The battery pack 33C is detachable from the battery-mounting part 31C. Similar to the first embodiment described above, one or more elastic members 60 is (are respectively) disposed between the motor and the battery-mounting part 31D to serve as vibration attenuation member(s) (vibration isolation member(s)).

The rated voltage of the battery pack 33D may be 18 V, 36 V, or 72 V, or any value between 18-72V.

### Specifications

In the present (fourth) embodiment, the maximum fastening torque of the anvil 16D, which is the output shaft, is 1,500 N·m or more. The specifications of the impact wrench 1D according to the present embodiment are as below.
Maximum fastening torque of output shaft: 1,500 N·m or more and less than 3,000 N·m
Rated voltage of battery pack: 18 V or more
Outer diameter Da of stator core: 50 mm
Maximum output of motor: 650 W
Rotational speed of output shaft (during no-load): 1,800 rpm
Impact rate of impact mechanism: 2,500 ipm
Speed-reduction ratio of speed-reducing mechanism: 1/15
Weight (mass) of hammer: 530 g
Distance Db between first side and second side of tip portion of anvil: ¾ inch (1.905 cm)
Weight (mass) of impact wrench when battery pack is not mounted: 5 kg

One or more battery packs, each having a rated voltage of 18 V, should be mounted on the impact wrench 1D such that the sum total of the rated voltage(s) of the battery pack(s) becomes 18 V or more. In the present embodiment, a battery pack 33D, which has a rated voltage of 36 V (max. 40 V), is preferably mounted on the impact wrench 1D. In this case, the sum total of the rated voltage(s) of the battery pack(s) is 36 V.

Another aspect of the present teachings can be summarized as follows.
An impact tool comprising:
a motor that rotates around a first rotational axis (motor rotational axis), which extends in an up-down direction;
a spindle that is rotated by the motor and rotates around a second rotational axis (output rotational axis), which is parallel to the first rotational axis;
a hammer, which is held on the spindle; and an anvil, which is impacted by the hammer;
wherein the anvil is disposed forward of the motor.

In the example shown in FIG. 7, the rotation from the rotor of the motor 10D is input to the speed-reducing mechanism 13D, which is one type of gear mechanism. The impact mechanism 15D is rotated by the rotation input from the gear mechanism. The rotational force of the motor 10D is transmitted, in order, to the gear mechanism, the impact mechanism 15D, and the anvil 16D. Because no impact is imparted to the gear mechanism, damage of the gear mechanism is curtailed, and therefore the gear mechanism can handle higher torque. It is noted that, although the gear mechanism in the example shown in FIG. 7 is a speed-reducing mechanism that reduces the rotational speed of the motor, it may instead be a speed-increasing mechanism that increases the rotational speed of the motor, i.e. such that the anvil 16D can rotate at a higher rotational speed than the rotor of the motor 10D.

### Effects

As explained above, the rated voltage of the battery pack 33D is 18 V or more. The outer diameter of the stator core is 50 mm or more. The maximum output of the motor 10D, which is a brushless motor, is 650 W or more. The rotational speed of the anvil 16D is 1,800 rpm. The impact rate of the impact mechanism 15D is 2,500 ipm. The weight (mass) of the hammer of the impact mechanism 15D is 530 g. The speed-reduction ratio of the speed-reducing mechanism 13D is 1/15. The distance between the first side and the second side, which oppose each other, of the tip portion of the anvil 16D is ¾ inch (1.905 cm) or more.

According to the above-mentioned configuration, the maximum fastening torque of the anvil 16D, which is the output shaft, can be made to be 1,500 N·m or more.

### Fifth Embodiment

A fifth embodiment will now be explained. In the explanation below, structural elements that are identical or equivalent to the embodiments described above are assigned the same symbols, and explanations of those structural elements are abbreviated or omitted.

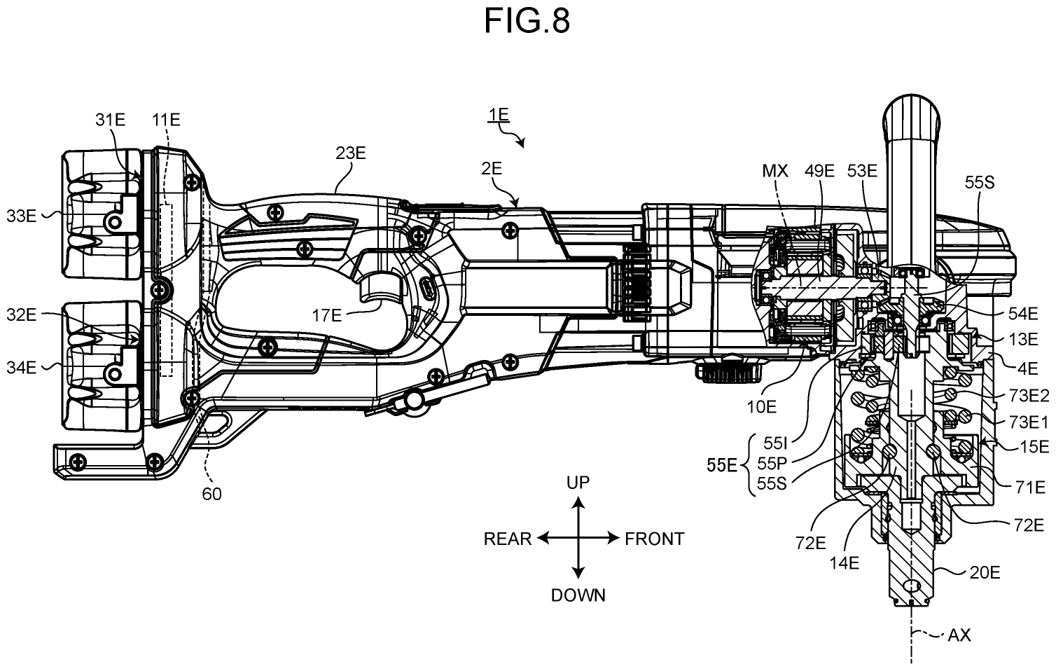

FIG. 8 is a side view that shows an impact wrench 1E according to the fifth embodiment. The impact wrench 1E according to the present embodiment is a modified example of the impact wrench 1A according to the first embodiment described above.

The impact wrench 1E comprises: a main-body housing 2E, which comprises a grip housing 23E; a first battery-mounting part 31E, on which a first battery pack 33E is mounted; a second battery-mounting part 32E, on which a second battery pack 34E is mounted; a motor 10E; a controller 11E; a speed-reducing mechanism 13E; a spindle shaft portion 14E; an impact mechanism 15E; an output shaft 20E; and a trigger switch 17E. Similar to the first embodiment described above, one or more elastic members 60 is (are respectively) disposed between the motor and the battery-mounting parts 31E, 32E to serve as vibration attenuation member(s) (vibration isolation member(s)).

In the present embodiment, the rotor shaft 49E of the motor 10E rotates around motor rotational axis MX, which extends in the front-rear direction. A first bevel gear 53E is provided at a front portion of a rotor shaft 49E of the motor 10E. The speed-reducing mechanism 13E comprises: a second bevel gear 54E, which meshes with the first bevel gear 53E; and a planetary-gear mechanism 55E. A sun gear 55S is disposed at (on) a lower portion of the second bevel gear 54E. The second bevel gear 54E and the sun gear 55S are fixed to each other. The second bevel gear 54E and the sun gear 55S may be integrally formed (i.e. in one piece without a seam or break therebetween). Thus, the second bevel gear 54E and the sun gear may be formed as a single member (structure). The planetary-gear mechanism 55E includes: a plurality of planet gears 55P, which are disposed around the sun gear 55S; an internal gear 55I, which is disposed around the planet gears 55P. The internal gear 55I is fixed to an inner surface of the gear case 4E.

The speed-reducing mechanism 13E, the impact mechanism 15E, and the output shaft 20E are each disposed more forward than the motor 10E. The speed-reducing mechanism 13E, the impact mechanism 15E, and the output shaft 20E each rotate around output rotational axis AX, which extends in the up-down direction. The output shaft 20E is an anvil that is impacted by the impact mechanism 15E. A socket is mounted on (at) a lower-end portion of the output shaft 20E.

The impact mechanism 15E includes: a hammer 71E; balls 72E; a first coil spring 73E1; and a second coil spring 73E2. The balls 72E are disposed between the spindle shaft portion 14E and the hammer 71E. The first and second coil springs 73E1 and 73E2 each generate an elastic force to bias the hammer 71E downward. The first and second coil springs are arranged coaxially or in parallel to each other. The second coil spring 73E2 is disposed radially inward (in the interior) of the first coil spring 73E1. The diameter of the first coil spring 73E1 is larger than the diameter of the second coil spring 73E2. The elastic force of the first coil spring 73E1 and the elastic force of the second coil spring 73E2 are different from each other.

The hammer 71E of the impact mechanism 15E is rotated by the rotational force that is output from the motor 10E and transmitted via at least four gear elements such that the hammer 71E rotates at a rotational speed less than the rotational speed of the rotor shaft 49E, but at an increased torque. Thus, in this embodiment, the hammer 71E of the impact mechanism 15E is rotated by the rotational force that is transmitted via the first bevel gear 53E and the speed-reducing mechanism 13E, which includes the second bevel gear 54E, the sun gear 55S, the planet gears 55P, and the internal gear 55I.

In the present (fifth) embodiment, the sum total of the rated voltages of the battery pack(s) is 18 V or more. The outer diameter Da of the stator core is 50 mm or more. The maximum output of the motor 10E is 400 W or more. The rotational speed of the output shaft 20E after the rotational speed has been reduced by the speed-reducing mechanism 13E is 2,000 rpm. The impact rate of the impact mechanism 15E is 2,500 ipm. The weight (mass) of the hammer of the impact mechanism 15E is 320 g. The speed-reduction ratio of the speed-reducing mechanism 13E is 1/9. Distance Db between the first side and the second side, which oppose each other, of the tip portion of the output shaft 20E is ½ inch (1.27 cm) or more. In the present embodiment as well, the maximum fastening torque of the output shaft 20E is 500 N·m or more.

In the example shown in FIG. 8, the rotation from the rotor of the motor 10E is input to the speed-reducing mechanism 13E, which is one type of gear mechanism. The impact mechanism 15E is rotated by the rotation input from the gear mechanism. The rotational force of the motor 10E is transmitted, in order, to the gear mechanism, the impact mechanism 15E, and the output shaft 20E. Because no impact is imparted to the gear mechanism, damage of the gear mechanism is curtailed, and therefore the gear mechanism can handle higher torque. In addition, in the example shown in FIG. 8, the length of the impact wrench 1E in the front-rear direction can be shortened as compared to embodiments, in which the impact mechanism 15E extends along the front-rear direction rather than along the up-down direction.

### Sixth Embodiment

A sixth embodiment will now be explained. In the explanation below, structural elements that are identical or equivalent to the embodiments described above are assigned the same symbols, and explanations of those structural elements are abbreviated or omitted.

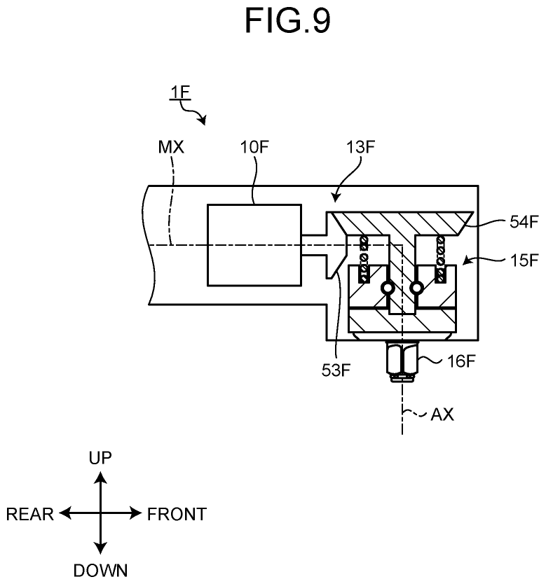

FIG. 9 schematically shows an impact wrench 1F according to the sixth embodiment.

The impact wrench 1F comprises a motor 10F, a speed-reducing mechanism 13F, an impact mechanism 15F, and an anvil 16F, which is the output shaft.

In the sixth embodiment, the rotor of the motor 10F rotates around motor rotational axis MX, which extends in the front-rear direction. The speed-reducing mechanism 13F is disposed more forward than the motor 10F. The speed-reducing mechanism 13F comprises a first bevel gear 53F and a second bevel gear 54F, which meshes with the first bevel gear 53F. The second bevel gear 54F is disposed more upward than a portion (e.g., a portion that contains the rotational axis MX) of the first bevel gear 53F. The second bevel gear 54F is disposed (preferably entirely disposed) more upward than motor rotational axis MX. The speed-reducing mechanism 13F is disposed rearward of the impact mechanism 15F. The rotation of the second bevel gear 54F is transmitted to the impact mechanism 15F. The impact mechanism 15F and the anvil 16F are each disposed more forward than the speed-reducing mechanism 13F. The impact mechanism 15F and the anvil 16F each rotate around output rotational axis AX, which extends in the up-down direction. The anvil 16F is impacted in the rotational direction around output rotational axis AX by the impact mechanism 15F. A socket is mounted on (at) a lower-end portion of the anvil 16F.

Although not shown, the same as in the embodiments described above, the impact wrench 1F comprises one or more battery-mounting parts, on which one or more battery packs is (are respectively) mounted. In the present embodiment as well, the maximum fastening torque of the anvil 16F is 500 N·m or more.

In the present (sixth) embodiment, because the second bevel gear 54F is disposed more upward than motor rotational axis MX, a space in which the hammer of the impact mechanism 15F is movable in the up-down direction can be ensured. Consequently, the length of the impact wrench 1F in the up-down direction can be shortened.

### Seventh Embodiment

A seventh embodiment will now be explained. In the explanation below, structural elements that are identical or equivalent to the embodiments described above are assigned the same symbols, and explanations of those structural elements are abbreviated or omitted.

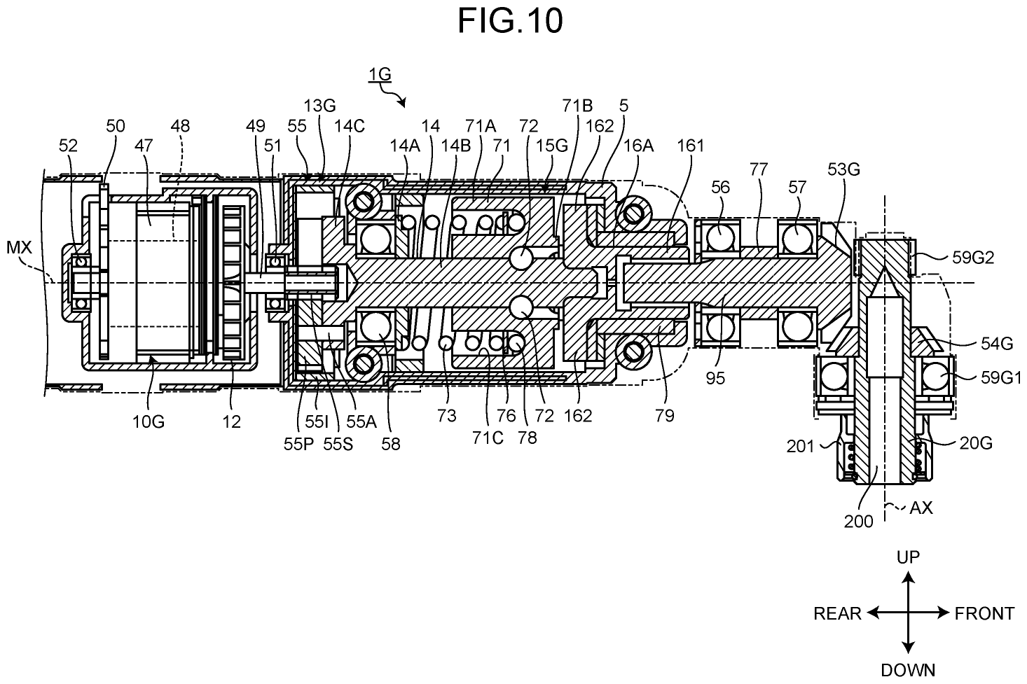

FIG. 10 is a cross-sectional view that shows a portion of an impact driver 1G according to the seventh embodiment. The impact driver 1G is an angle impact driver, which is one type of angle impact tool. The impact driver 1G comprises an output shaft 20G, which has a bit hole 200 into which a driver bit is insertable. The output shaft 20G rotates around output rotational axis AX, which extends in the up-down direction. The output shaft 20G is supported in (by) bearings 59G1, 59G2 in a rotatable manner. Preferably, bearing 59G1 is a rolling element bearing (e.g., a ball bearing) and bearing 59G2 is a plain bearing, although both optionally may be rolling element bearings. A bit-retaining mechanism 201 is provided on the output shaft 20G. The bit-retaining mechanism 201 retains a driver bit that has been inserted into the bit hole 200.

A second bevel gear 54G is fixed to the output shaft 20G. The second bevel gear 54G meshes with a first bevel gear 53G. The rotational force of a motor 10G is transmitted to the output shaft 20G via a speed-reducing mechanism 13G, an impact mechanism 15G, the first bevel gear 53G, and the second bevel gear 54G. Structural elements other than the output shaft 20G are the same as those in the impact wrench 1A according to the first embodiment described above.

In the present embodiment as well, the maximum fastening torque of the output shaft 20G is 500 N·m or more.

### Relationship Among Rated Voltages of Battery Pack(s), Outer Diameter of Stator, and Maximum Fastening Torque

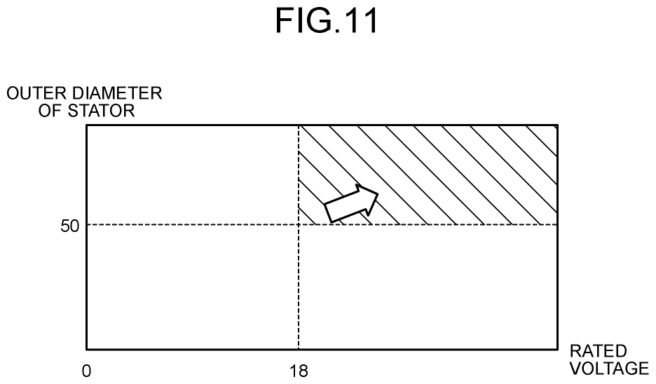

FIG. 11 shows the relationship among the rated voltages of the battery pack(s), the outer diameter of the stator core, and the maximum fastening torque of the output shaft according to the embodiment. As shown in FIG. 11, in embodiments in which (the sum total of) the rated voltage(s) of the battery pack(s) is 18 V or more and the outer diameter of the stator core is 50 mm or more, the maximum fastening torque of the output shaft can be made to be 500 N·m or more.

### Other Embodiments

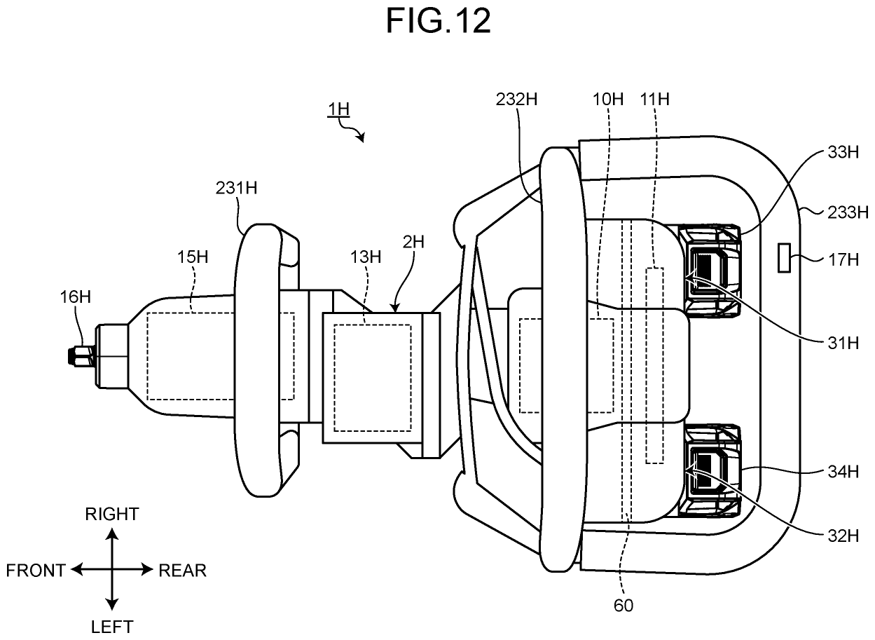

FIG. 12 shows an impact wrench 1H according to another embodiment. The impact wrench 1H comprises: a main-body housing 2H; a first grip part 231H, which is fixed to the main-body housing 2H; a second grip part 232H, which is disposed more rearward than the first grip part 231H; a third grip part 233H, which is disposed more rearward than the second grip part 232H; a motor 10H, which is housed in the main-body housing 2H; a controller 11H, which is disposed more rearward than the motor 10H; a speed-reducing mechanism 13H, which is disposed more forward than the motor 10H; an impact mechanism 15H, which is disposed more forward than the speed-reducing mechanism 13H; an anvil 16H, which is impacted in the rotational direction by the impact mechanism 15H and functions as an output shaft; and a trigger switch 17H, which is provided on the third grip part 233H.

In addition, the impact wrench 1H comprises a first battery-mounting part 31H, on which a first battery pack 33H is mounted; and a second battery-mounting part 32H, on which a second battery pack 34H is mounted. Similar to the first embodiment described above, one or more elastic members 60 is (are respectively) disposed between the motor and the battery-mounting parts 31H, 32H to serve as vibration attenuation member(s) (vibration isolation member(s)).

The first grip part 231H is provided such that it protrudes upward from a front portion of the main-body housing 2H. The first grip part 231H has a loop shape. The second grip part 232H is provided such that it protrudes upward from a center portion of the main-body housing 2H in the front-rear direction. The second grip part 232H has a loop shape. The third grip part 233H is provided such that it protrudes rearward from a rear portion of the main-body housing 2H. The third grip part 233H has a loop shape. A lower-end portion of the second grip part 232H and a front-end portion of the third grip part 233H are connected to each other.

When the user grips the first grip part 231H or the second grip part 232H with, for example, their right hand and grips the third grip part 233H with their left hand, the user can perform fastening work.

The specifications of the impact wrench 1H according to the present embodiment are as below. In this embodiment, the weight (mass) of the hammer is preferably at least 1 kg.
Maximum fastening torque of output shaft: 3,000 N·m
Sum total of rated voltages of battery packs: 36 V
Outer diameter Da of stator core: 80 mm
Maximum output of motor: 650 W
Rotational speed of output shaft (during no-load): 1,200 rpm
Impact rate of impact mechanism: 1,800 ipm
Speed-reduction ratio of speed-reducing mechanism: 1/30
Weight (mass) of hammer: 1.1 kg
Distance Db between first side and second side of tip portion of anvil: 2 inch (2.54 cm)
External dimensions of impact wrench when battery pack(s) is (are) not mounted: 560 mm (front-rear direction)×240 mm (left-right direction)×350 mm (up-down direction)
Weight (mass) of impact wrench when battery pack(s) is (are) not mounted: 10 kg

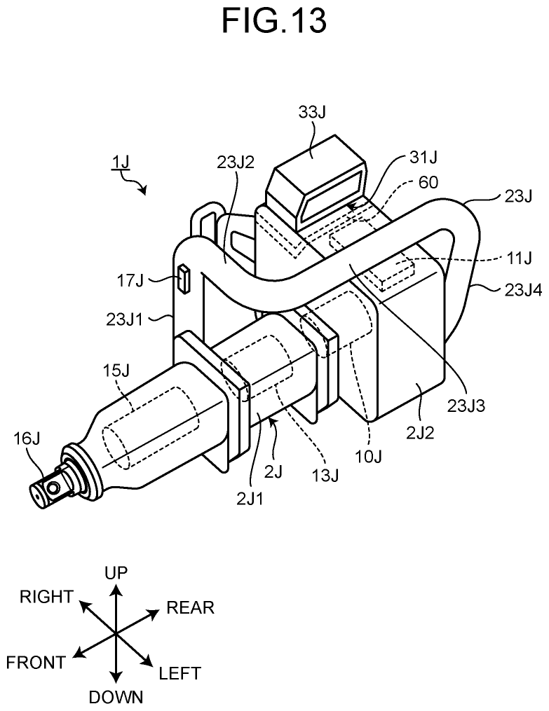

FIG. 13 shows an impact wrench 1J according to another embodiment. The impact wrench 1J comprises: a main-body housing 2J; a grip housing 23J, which is fixed to the main-body housing 2J; a motor 10J, which is housed in the main-body housing 2J; a controller 11J, which is disposed more rearward than the motor 10J; a speed-reducing mechanism 13J, which is disposed more forward than the motor 10J; an impact mechanism 15J, which is disposed more forward than the speed-reducing mechanism 13J; an anvil 16J, which is impacted in the rotational direction by the impact mechanism 15J and functions as an output shaft; and a trigger switch 17J, which is provided on the grip housing 23J. One or more elastic members 60 is (are respectively) disposed between the motor and the battery-mounting part 31J to serve as vibration attenuation member(s) (vibration isolation member(s)).

The main-body housing 2J comprises a motor-housing part 2J1 and a controller-housing part 2J2, which is disposed rearward of the motor-housing part 2J1. The grip housing 23J comprises: a first portion 23J1, which extends upward from a right portion of the motor-housing part 2J1; a second portion 23J2, which extends leftward from an upper-end portion of the first portion 23J1; a third portion 23J3, which extends rearward from a left-end portion of the second portion 23J2; and a fourth portion 23J4, which extends downward from a rear-end portion of the third portion 23J3. The fourth portion 23J4 is disposed more rearward than the controller-housing part 2J2.

In the state in which the user has gripped the first portion 23J1 or the second portion 23J2 with, for example, their right hand and has gripped the fourth portion 23J4 with their left hand, the user can perform fastening work.

In addition, the impact wrench 1J comprises a battery-mounting part 31J, on which a battery pack 33J is mounted.

The specifications of the impact wrench 1J according to the present embodiment are as below.
Maximum fastening torque of output shaft: 7,500 N·m
Rated voltage of battery pack: 72 V
Outer diameter Da of stator core: 80 mm
Maximum output of motor: 650 W
Rotational speed of output shaft (during no-load): 760 rpm
Impact rate of impact mechanism: 1,000 ipm
Speed-reduction ratio of speed-reducing mechanism: 1/39.4
Weight (mass) of hammer: 4.5 kg
Distance Db between first side and second side of tip portion of anvil: 1.5 inches (3.81 cm)
External dimensions of impact wrench when battery pack is not mounted: 560 mm (front-rear direction)×240 mm (left-right direction)×350 mm (up-down direction)
Weight (mass) of impact wrench when battery pack is not mounted: 20 kg

It is noted that the specifications of the impact wrench 1J may be as below.
Maximum fastening torque of output shaft: 7,500 N·m or more
Rated voltage of battery pack: 72 V
Outer diameter Da of stator core: 80 mm
Maximum output of motor: 650 W
Rotational speed of output shaft (during no-load): 1,150 rpm
Impact rate of impact mechanism: 1,500 ipm
Speed-reduction ratio of speed-reducing mechanism: 1/26.3
Weight (mass) of hammer: 2.0 kg
Distance Db between first side and second side of tip portion of anvil: 1.5 inches
External dimensions of impact wrench when battery pack is not mounted: 560 mm (front-rear direction)×240 mm (left-right direction)×350 mm (up-down direction)
Weight (mass) of impact wrench when battery pack is not mounted: 20 kg

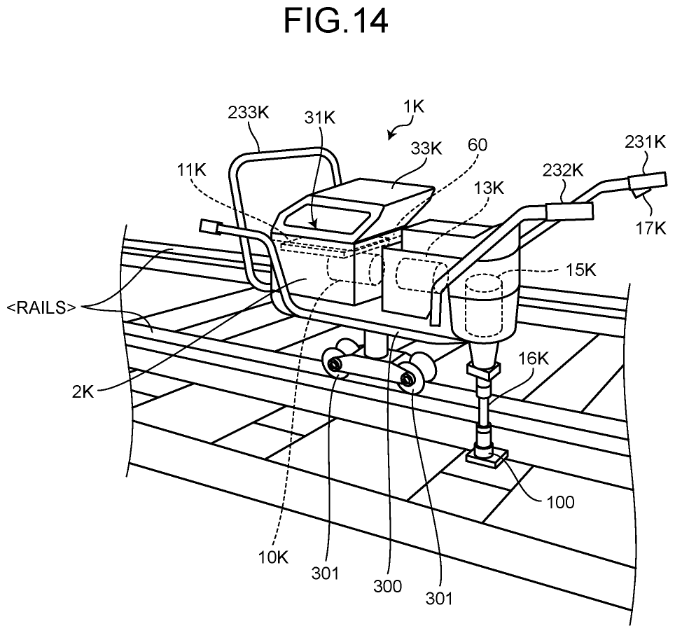

FIG. 14 shows an impact wrench 1K according to another embodiment. The impact wrench 1K comprises: a main-body housing 2K; a first grip part 231K and a second grip part 232K, which are fixed to the main-body housing 2K; a third grip part 233K, which is fixed to the main-body housing 2K; a motor 10K, which is housed in the main-body housing 2K; a controller 11K, which is disposed more upward than the motor 10K; a speed-reducing mechanism 13K, which is disposed more forward than the motor 10K; an impact mechanism 15K, which is disposed more forward than the speed-reducing mechanism 13K; an anvil 16K, which is impacted in the rotational direction by the impact mechanism 15K and functions as an output shaft; and a trigger switch 17K, which is provided on the first grip part 231K. A socket 100 is mounted on (at) a lower-end portion of the anvil 16K.

In addition, the impact wrench 1K comprises a battery-mounting part 31K, on which a battery pack 33K is mounted. The battery-mounting part 31K is disposed at an upper portion of the main-body housing 2K. Similar to the first embodiment described above, one or more elastic members 60 is (are respectively) disposed between the motor and the battery-mounting part 31K to serve as vibration attenuation member(s) (vibration isolation member(s)).

In addition, the impact wrench 1K comprises a pedestal 300, which supports the main-body housing 2K, and wheels 301, which support the pedestal 300. The wheels 301 travel on rails on which a railway vehicle travels. The impact wrench 1K is used to fasten bolts or nuts that fix, for example, railroad ties.

The specifications of the impact wrench 1K according to the present embodiment are as below.
Maximum fastening torque of output shaft: 7,500 N·m
Rated voltage of battery pack: 75 V
Outer diameter Da of stator core: 80 mm
Maximum output of motor: 650 W
Rotational speed of output shaft (during no-load): 761 rpm
Impact rate of impact mechanism: 1,000 ipm
Speed-reduction ratio of speed-reducing mechanism: 1/39.4
Weight (mass) of hammer: 4.5 kg
Distance Db between first side and second side of tip portion of anvil: 1.5 inches (3.81 cm)
External dimensions of impact wrench when battery pack is not mounted: 1,500 mm (front-rear direction)×590 mm (left-right direction)×800 mm (up-down direction)
Weight (mass) of impact wrench when battery pack is not mounted: 20 kg

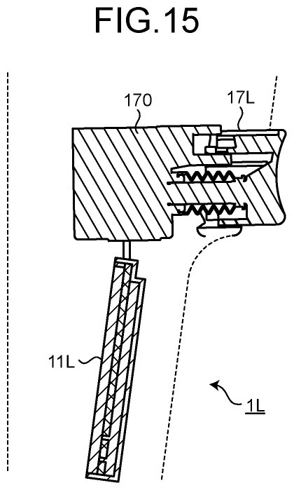

FIG. 15 schematically shows a portion of an angle impact tool 1L according to another embodiment. In each of the embodiments described above, it is assumed that the trigger switch (17A, etc.) and the controller (11A, etc.) are spaced apart from each other. As shown in FIG. 15, a trigger switch 17L and a controller 11L may be integrally connected. More specifically, the trigger switch 17L is connected to a switch main body 170. The switch main body 170 is integral with the controller 11L. Thus, the trigger switch 17L, the switch main body 170, and the controller 11L are an integral unit.

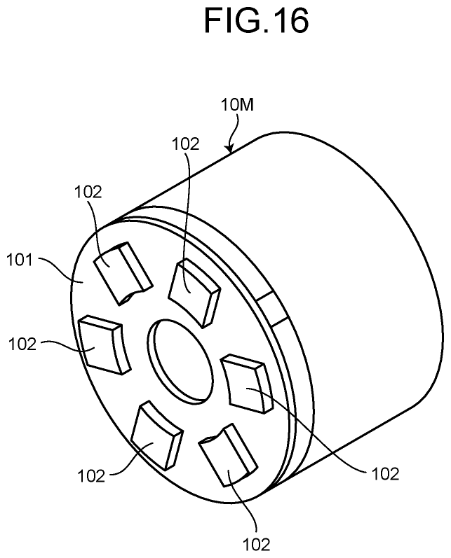

FIG. 16 schematically shows a motor 10M according to another embodiment. FETs 102, which are for switching the drive current supplied to the motor 10M, may be disposed on a board 101, which is integral with the motor 10M.

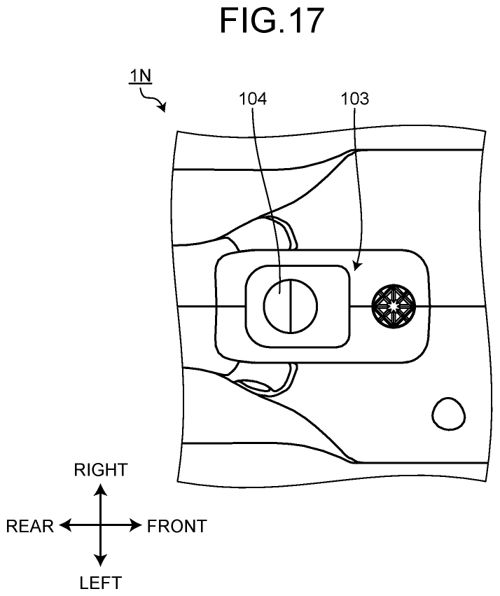

FIG. 17 shows a portion of an angle impact tool 1N according to another embodiment. As shown in FIG. 17, a switch panel 103 may be disposed on a portion of the angle impact tool 1N. The switch panel 103 may be disposed on at least a portion of the main-body housing (2A, etc.). The rotational speed of the motor may be changed by manipulating (e.g., pressing, rotating, sliding) a switch 104, which is provided on the switch panel 103. For example, in the example shown in FIG. 1, the switch panel 103 may be disposed at (on) an upper portion of the main-body housing 2A.

Preferably, the impact wrench 1A-1N of one or more of the above-described embodiments is configured to convert continuous torque input from the brushless motor 10A into the maximum fastening torque without exceeding 80 A of current drawn by the brushless motor 10A.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved impact wrenches and similar power tools.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### EXPLANATION OF THE REFERENCE NUMBERS

1A Impact wrench
1B Impact wrench
1C Impact wrench
1D Impact wrench
1E Impact wrench
1F Impact wrench
1G Impact driver
1H Impact wrench
1J Impact wrench
1K Impact wrench
2A Main-body housing
2B Main-body housing
2C Main-body housing
2D Main-body housing
2E Main-body housing
2H Main-body housing
2J Main-body housing
2K Main-body housing
Gear housing
7 Handle
10A Motor
10B Motor
10C Motor
10D Motor
10E Motor
10F Motor
10G Motor
10H Motor
10J Motor
10K Motor
11A Controller
11B Controller
11C Controller
11D Controller
11E Controller
11H Controller
11J Controller
11K Controller
12 Fan
13A Speed-reducing mechanism
13B Speed-reducing mechanism
13C Speed-reducing mechanism
13D Speed-reducing mechanism
13E Speed-reducing mechanism
13F Speed-reducing mechanism
13G Speed-reducing mechanism
13H Speed-reducing mechanism
13J Speed-reducing mechanism
13K Speed-reducing mechanism
14 Spindle
14A Flange portion
14B Spindle-shaft portion
14C Protruding part
15A Impact mechanism
15B Impact mechanism
15C Impact mechanism
15D Impact mechanism
15E Impact mechanism
15F Impact mechanism
15G Impact mechanism
15H Impact mechanism
15J Impact mechanism
15K Impact mechanism
16A Anvil
16D Anvil
16F Anvil
16H Anvil
16J Anvil
16K Anvil
17A Trigger switch
17B Trigger switch
17C Trigger switch
17D Trigger switch
17E Trigger switch
17H Trigger switch
17J Trigger switch
17K Trigger switch
20A Output shaft
20B Output shaft
20C Output shaft
20E Output shaft
20G Output shaft
21 Motor housing
23A Grip housing
23B Grip housing
23C Grip housing
23D Grip housing
23E Grip housing
23J Grip housing
24 Controller housing
31A First battery-mounting part
31B Battery-mounting part
31C Battery-mounting part
31D Battery-mounting part
31E First battery-mounting part
31H First battery-mounting part
31J Battery-mounting part
31K Battery-mounting part
32A Second battery-mounting part
32E Second battery-mounting part
32H Second battery-mounting part
33A First battery pack
33B Battery pack
33C Battery pack
33D Battery pack
33E First battery pack
33H First battery pack
33J Battery pack
33K Battery pack
34A Second battery pack
34E Second battery pack
34H Second battery pack
47 Stator
47A Stator core
47B Coil
48 Rotor
49 Rotor shaft
49E Rotor shaft
50 Sensor board
51 Rotor bearing
52 Rotor bearing
53 Bevel gear
53E Bevel gear
53F Bevel gear
53G Bevel gear
54 Bevel gear
54E Bevel gear
54F Bevel gear
54G Bevel gear
55 Planetary-gear mechanism
55A Pin
55I Internal gear
55P Planet gear
55S Sun gear
56 Shaft bearing
57 Shaft bearing
58 Spindle bearing
59 Shaft bearing
59G Bearing
71 Hammer
71A Hammer body
71B Hammer-projection portion
71C Recessed portion
72 Ball
73 Coil spring
76 Washer
77 Spacer
78 Ball
79 Anvil bearing
95 Intermediate shaft
100 Socket
161 Anvil-shaft portion
162 Anvil-projection portion
200 Bit hole
201 Bit-retaining mechanism
231 First grip part
231H First grip part
231K First grip part
232 Second grip part
232H Second grip part
232K Second grip part
233H Third grip part
233K Third grip part
300 Pedestal
301 Wheel
Da Outer diameter
Db Distance
MX Motor rotational axis
AX Output rotational axis

1. An angle impact tool comprising:
a brushless motor comprising a stator and a rotor, which rotates around a first rotational axis relative to the stator;
an impact mechanism, which is rotated by the rotor;
an output shaft, which is impacted by the impact mechanism and rotates around a second rotational axis;
a motor housing, which houses the brushless motor; and
one or more battery-mounting parts, on which one or more battery packs is (are respectively) mounted;
wherein:
the impact mechanism and the output shaft are disposed more forward than the brushless motor in a front-rear direction;
the front-rear direction and the output shaft are orthogonal to each other; and
the maximum fastening torque of the output shaft is 500 N·m or more and less than 1,000 N·m.

2. The angle impact tool according to claim 1, wherein:
the rated voltage(s) of the battery pack(s) is 18 V or more; and
the outer diameter of the stator is 50 mm or more.

3. The angle impact tool according to claim 2, wherein the maximum output of the brushless motor is 400 W or more.

4. The angle impact tool according to claim 2, further comprising:
a speed-reducing mechanism, which reduces the speed of the rotation of the rotor and transmits such rotation to the impact mechanism;
wherein the angle impact tool is configured to rotate the output shaft at a rotational speed of 1,000 rpm or more and 4,000 rpm or less.

5. The angle impact tool according to claim 2, wherein the angle impact tool is configured such that the impact rate of the impact mechanism is 1,250 ipm or more and 5,000 ipm or less.

6. The angle impact tool according to claim 2, wherein the weight of a hammer of the impact mechanism is 160 g or more and 640 g or less.

7. The angle impact tool according to claim 2, further comprising:
a speed-reducing mechanism, which reduces the speed of the rotation of the rotor and transmits such rotation to the impact mechanism;
wherein the speed-reduction ratio of the speed-reducing mechanism is 1/18.0 or more and 1/4.5 or less.

8. The angle impact tool according to claim 2, wherein:
a tip portion of the output shaft, on which a socket is mountable, has a square-columnar shape; and
the distance between a first side and a second side, which oppose each other, of the tip portion of the output shaft is ½ inch or more and 2.5 inches or less.

9. An angle impact tool comprising:
a brushless motor comprising a stator and a rotor, which rotates around a first rotational axis relative to the stator;
an impact mechanism, which is rotated by the rotor;
an output shaft, which is impacted by the impact mechanism and rotates around a second rotational axis;
a motor housing, which houses the brushless motor; and
one or more battery-mounting parts, on which one or more battery packs is (are respectively) mounted;
wherein:
the impact mechanism and the output shaft are disposed more forward than the brushless motor in a front-rear direction;
the front-rear direction and the output shaft are orthogonal to each other; and
the maximum fastening torque of the output shaft is 1,000 N·m or more and less than 1,500 N·m.

10. The angle impact tool according to claim 9, wherein:
the rated voltage(s) of the battery pack(s) is 18 V or more; and
the outer diameter of the stator is 50 mm or more.

11. The angle impact tool according to claim 10, wherein the maximum output of the brushless motor is 500 W or more.

12. The angle impact tool according to any claim 10, further comprising:
a speed-reducing mechanism, which reduces the speed of the rotation of the rotor and transmits such rotation to the impact mechanism;
wherein the angle impact tool is configured to rotate the output shaft at a rotational speed of 800 rpm or more and 3,200 rpm or less.

13. The angle impact tool according to claim 10, wherein the impact rate of the impact mechanism is 1,100 ipm or more and 4,400 ipm or less.

14. The angle impact tool according to claim 10, wherein the weight of a hammer of the impact mechanism is 310 g or more and 1,240 g or less.

15. The angle impact tool according to claim 10, comprising:
a speed-reducing mechanism, which reduces the speed of the rotation of the rotor and transmits such rotation to the impact mechanism;
wherein the speed-reduction ratio of the speed-reducing mechanism is 1/20.0 or more and 1/5.0 or less.

16. The angle impact tool according to any claim 10, wherein:
a tip portion of the output shaft, on which a socket is mountable, has a square-columnar shape; and
the distance between a first side and a second side, which oppose each other, of the tip portion of the output shaft is ½ inch or more and 2.5 inches or less.

17. An angle impact tool comprising:
a brushless motor comprising a stator and a rotor, which rotates around a first rotational axis relative to the stator;
an impact mechanism, which is rotated by the rotor;
an output shaft, which is impacted by the impact mechanism and rotates around a second rotational axis;
a motor housing, which houses the brushless motor; and
one or more battery-mounting parts, on which one or more battery packs is (are respectively) mounted;
wherein:
the impact mechanism and the output shaft are disposed more forward than the brushless motor in a front-rear direction;
the front-rear direction and the output shaft are orthogonal to each other; and
the maximum fastening torque of the output shaft is 1,500 N·m or more and less than 3,000 N·m.

18. The angle impact tool according to claim 17, wherein:
the rated voltage(s) of the battery pack(s) is 18 V or more; and
the outer diameter of the stator is 50 mm or more.

19. The angle impact tool according to claim 18, wherein the maximum output of the brushless motor is 650 W or more.

20. The angle impact tool according to claim 18, further comprising:
a speed-reducing mechanism, which reduces the speed of the rotation of the rotor and transmits such rotation to the impact mechanism;
wherein the angle impact tool is configured to rotate the output shaft at a rotational speed of 900 rpm or more and 3,600 rpm or less.

21. The angle impact tool according to claim 18, wherein the angle impact tool is configured such that the impact rate of the impact mechanism is 1,250 ipm or more and 5,000 ipm or less.

22. The angle impact tool according to claim 18, wherein the weight of a hammer of the impact mechanism is 265 g or more and 1,060 g or less.

23. The angle impact tool according to claim 18, further comprising:
a speed-reducing mechanism, which reduces the speed of the rotation of the rotor and transmits such rotation to the impact mechanism;
wherein the speed-reduction ratio of the speed-reducing mechanism is 1/30.0 or more and 1/7.5 or less.

24. The angle impact tool according to claim 18, wherein:
a tip portion of the output shaft, on which a socket is mountable, has a square-columnar shape; and
the distance between a first side and a second side, which oppose each other, of the tip portion of the output shaft is ¾ inch (1.905 cm) or more and 2.5 inches (6.35 cm) or less.

25. The angle impact tool according to claim 1, comprising:
a gear mechanism, into which rotation from the impact mechanism is input;
wherein the output shaft is configured to be rotated by the rotation input from the gear mechanism.

26. The angle impact tool according to claim 1, comprising:
a gear mechanism, into which rotation from the rotor is input;
wherein the impact mechanism is configured to be rotated by the rotation input from the gear mechanism.

27. The angle impact tool according to claim 1, wherein:
a rotational axis of the rotor extends in the front-rear direction, and
a spring biases a hammer of the impact mechanism forward toward the anvil.

28. The angle impact tool according to claim 27, wherein the impact mechanism is configured such that the hammer of the impact mechanism imparts consecutive rotational impacts on an anvil of the output shaft at a rate of two impacts per rotation of the hammer.

29. The angle impact tool according to claim 27, wherein the hammer of the impact mechanism is rotated by the rotational force that is output from the motor and then transmitted via four or more gear elements.

30. The angle impact tool according to claim 1, wherein:
a stator core of the stator includes a plurality of stacked steel plates, and
the length of the stacked steel plates in a direction of the first rotational axis of the rotor is 24 mm or more.

31. The angle impact tool according to claim 1, further comprising:
a first grip extending from the motor housing; and
a support part extending from the motor housing disposed downward of the grip.

32. The angle impact tool according to claim 31, further comprising a handle.

33. The angle impact tool according to claim 32, wherein the handle has a loop shape.

34. The angle impact tool according to claim 32, wherein the handle is pivotable relative to the motor housing.

35. The angle impact tool according to claim 1, wherein:
a rotor core of the rotor contains a first number of rotor magnets,
the stator contains a second number of teeth, and
the first number is greater than the second number.

36. The angle impact tool according to claim 35, wherein:
the brushless motor is configured to output a motor torque of 2.0 N·m or more and 11.0 N·m or less, and
the brushless motor is configured to rotate the rotor at a rotational speed of 3,000 rpm or more and 4,300 rpm or less.

37. The angle impact tool according to claim 36, wherein the brushless motor includes:
at least one coil wound on a stator core of the stator; and
the rotor magnets fixed to the rotor core;
wherein:
the rotor magnets have a residual magnetic flux density of 1.32 T or more; and
the rotor magnets have a coercive force of 971 kA/m or more.

38. The angle impact tool according to claim 1, further comprising an elastic member disposed between the brushless motor and the one or more battery-mounting parts.

39. The angle impact tool according to claim 1, wherein:
the (each) battery pack has a nominal voltage of at least 36 volts and a nominal capacity of at least 5 Ah, and
the angle impact tool is configured to convert continuous torque input from the brushless motor into the maximum fastening torque of the output shaft without exceeding 80 A of current drawn by the brushless motor.

40. The angle impact tool according to claim 1, wherein the mass of a hammer of the impact mechanism is at least 1 kg.

41. The angle impact tool according to claim 1, wherein two or more springs are arranged coaxially or in parallel to bias a hammer of the impact mechanism forward in the front-rear direction.
